(19) United States
(12) Patent Application Publication
(10) Pub. No.: US 2023/0375737 A1
(43) Pub. Date: Nov. 23, 2023

(54) SYSTEMS AND METHODS FOR LOCATING, MAPPING, AND IDENTIFYING SUBTERRANEAN PIPELINES

(71) Applicant: White River Technologies, Inc., Newton, MA (US)

(72) Inventors: Jonathan MILLER, Bethel, VT (US); Gregory SCHULTZ, Quechee, VT (US)

(21) Appl. No.: 18/087,291

(22) Filed: Dec. 22, 2022

Related U.S. Application Data
(60) Provisional application No. 63/342,719, filed on May 17, 2022.

(51) Int. Cl. G01V 3/10

(52) U.S. Cl. CPC G01V 3/104

(57) ABSTRACT

Methods and systems are provided for determining the material composition of subterranean metal objects. By propagating an electromagnetic field through the ground and impinging upon the metal object, eddy currents form that generate a secondary magnetic field that can be measured. The measured field can be compared to existing, model data to determine the material composition of the metal object.

### CROSS REFERENCE TO RELATED APPLICATIONS

The present application claims the benefit and priority, under 35 U.S.C. § 119(e), to U.S. Provisional Application Ser. No. 63/342,719, filed on May 17, 2022, entitled “SYSTEMS AND METHODS FOR LOCATING, MAPPING, AND IDENTIFYING SUBTERRANEAN PIPELINES,” the entire disclosure of which is hereby incorporated herein by reference, in its entirety, for all that it teaches and for all purposes.

### BACKGROUND

The present disclosure is generally directed to electromagnetic induction and relates more particularly to identifying the composition of subterranean objects, such as pipes, using electromagnetic induction.

### SUMMARY

Subterranean objects are widely used in many fields for enabling, for example, plumbing and some forms of signal communication. The subterranean objects often include metals or metallic objects, or are otherwise at least partially constructed with or made of metal. However, once a subterranean object, such as a metal pipe, has been placed, it can be difficult to assess the pipe's condition. Furthermore, the exact location of subterranean objects may not be well documented when placed or constructed, meaning their exact location may be difficult to determine once buried. Aspects of the present disclosure address such aforementioned issues by enabling the location and material composition of a subterranean structure to be determined. By inducing and measuring an electromagnetic field in the metal object, and by processing the measurements, the material composition and location of the metal object can be determined without needing to resort to excavation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an electromagnetic (EM) induction system in accordance with embodiments of the present disclosure;

FIG. 2 shows transmitter coils inducing eddy currents in a pipe in accordance with embodiments of the present disclosure;

FIG. 3 is a diagram of polarizability of the pipe in accordance with embodiments of the present disclosure;

FIG. 4 is a dipole model in accordance with embodiments of the present disclosure;

FIG. 5A shows a testbed for determine the material composition of pipes in accordance with embodiments of the present disclosure;

FIG. 5B shows results of the EM induction system surveying the testbed in accordance with embodiments of the present disclosure;

FIG. 6A shows a library match analysis of a lead pipe with a steel pipe library in accordance with embodiments of the present disclosure;

FIG. 6B shows a library match analysis of a lead pipe with a lead pipe library in accordance with embodiments of the present disclosure;

FIG. 6C shows a library match analysis of a lead pipe with a copper pipe library in accordance with embodiments of the present disclosure;

FIG. 6D shows a library match analysis of a copper pipe with a steel pipe library in accordance with embodiments of the present disclosure;

FIG. 6E shows a library match analysis of a copper pipe with a lead pipe library in accordance with embodiments of the present disclosure;

FIG. 6F shows a library match analysis of a copper pipe with a copper pipe library in accordance with embodiments of the present disclosure;

FIG. 6G shows a library match analysis of a steel pipe with a steel pipe library in accordance with embodiments of the present disclosure;

FIG. 6H shows a library match analysis of a steel pipe with a lead pipe library in accordance with embodiments of the present disclosure;

FIG. 6I shows a library match analysis of a steel pipe with a copper pipe library in accordance with embodiments of the present disclosure;

FIG. 7A shows a parameter space analysis in accordance with embodiments of the present disclosure;

FIG. 7B shows a parameter space analysis at a 50 cm depth in accordance with embodiments of the present disclosure;

FIG. 7C shows a parameter space analysis at a 60 cm depth in accordance with embodiments of the present disclosure;

FIG. 7D shows a parameter space analysis at a 70 cm depth in accordance with embodiments of the present disclosure;

FIG. 7E shows a parameter space analysis at an 80 cm depth in accordance with embodiments of the present disclosure;

FIG. 7F shows a parameter space analysis at a 90 cm depth in accordance with embodiments of the present disclosure;

FIG. 7G shows a parameter space analysis at a 100 cm depth in accordance with embodiments of the present disclosure;

FIG. 7H shows a parameter space analysis at a 110 cm depth in accordance with embodiments of the present disclosure;

FIG. 8A shows a system in accordance with embodiments of the present disclosure;

FIG. 8B shows additional components of the system in accordance with embodiments of the present disclosure;

FIG. 9 shows a flowchart in accordance with embodiments of the present disclosure;

FIG. 10 displays an output graphic in accordance with embodiments of the present disclosure; and

FIG. 11 displays a user interface in accordance with embodiments of the present disclosure.

### DETAILED DESCRIPTION

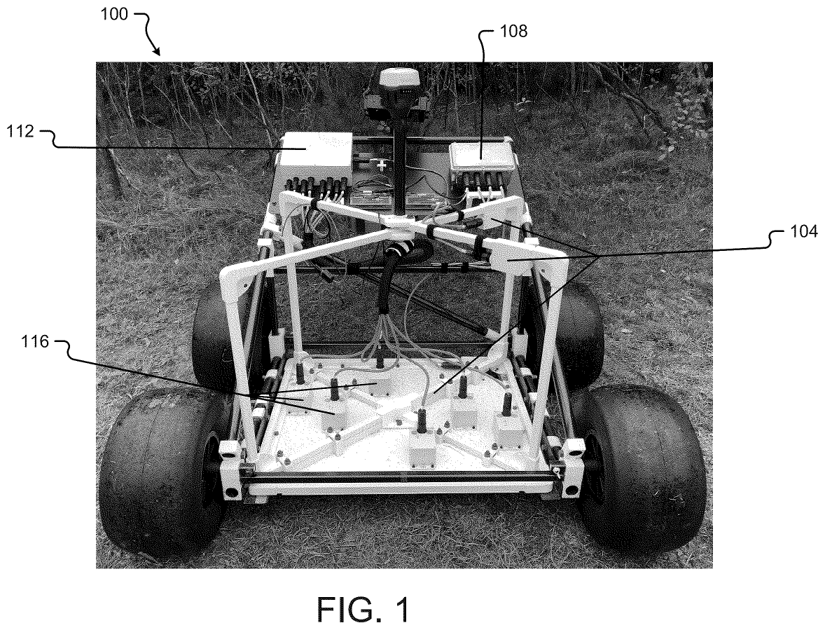

FIG. 1 illustrates an EM induction system 100 according to at least one embodiment of the present disclosure. The EM induction system 100 may be a mobile apparatus capable of being movable by a human, self-powered, and/or motorized or guided by, for example, GPS and that is capable of generating EM fields at and/or below the ground surface. In some embodiments, the EM induction system 100 may generate multi-directional (e.g., in an X-axis direction, in a Y-axis direction, in a Z-axis direction, and/or combinations thereof) and/or low-frequency magnetic fields below the ground surface. In some embodiments, the fields may be impervious or otherwise unaffected by soil conditions (e.g., the fields may avoid interacting with any magnetic properties of the soil) and may be able to propagate into the subsurface of the soil. As a result, the magnetic fields may be able to impinge upon a subterranean metal object (e.g., a pipeline or other object) to facilitate identification of the composition (e.g., determine whether the object is copper, lead, etc.), the orientation, and other properties of the pipe, such as deterioration, as discussed below.

The EM induction system 100 may include one or more transmitter coils 104. The transmitter coils 104 may be or comprise air-cored induction coils, induction coils, solenoids (e.g., coiled or looped wire through which a current can be passed to generate a magnetic field), ferromagnetic material (e.g., iron, iron alloys, cobalt, cobalt alloys, nickel, nickel alloys, etc.), and/or any other material or object capable of generating a magnetic field. In some embodiments, a single transmitter coil may be used.

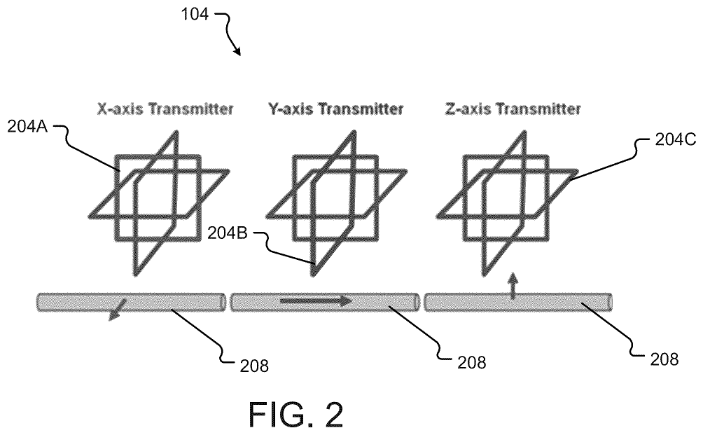

As illustrated in FIG. 2, the transmitter coils 104 may include an array of coils capable of generating three-dimensional (3D) magnetic field energy. The transmitter coils 104 comprise an X-axis transmitter 204A, a Y-axis transmitter 204B, and a Z-axis transmitter 204C. The X-axis transmitter 204A, the Y-axis transmitter 204B, and the Z-axis transmitter 204C may be oriented such that a plane formed by each transmitter is perpendicular to the other two planes formed by the other two transmitters (e.g., a plane parallel to the X-axis transmitter 204A is perpendicular to the planes respectively parallel to the Y-axis transmitter 204B and the Z-axis transmitter 204C). While the transmitter coils 104 depicted in FIG. 2 are orthogonal, the transmitters may alternatively be non-orthogonal. Moreover, while FIG. 2 depicts three transmitter coils, an additional or alternative number of transmitter coils may be used (e.g., two coils, four coils, six coils, etc.). In some embodiments, the transmitter coils 104 may be able to move relative to one another. The positioning of the planes (and by extension the transmitter coils 104) may enable the EM induction system 100 to propagate 3D magnetic field energy utilizing multiple (e.g., two or more) transmitter coils 104, resulting in eddy currents in a subsurface object (e.g., a pipe 208, a pipeline, etc.) in all three directions of space, resulting in a more complete data set. As the EM induction system 100 operates, magnetic fields generated by the transmitter coils 104 may impinge upon a metal object (e.g., the pipe 208) and induce eddy currents in the metal object. The eddy currents may rapidly decay and generate a time-varying secondary magnetic field that may be detected by the EM induction system 100. The presence of the X-axis transmitter 204A, the Y-axis transmitter 204B, and the Z-axis transmitter 204C may enable eddy current response in the pipe 208 that can be described as temporary electromagnetic polarizability of the pipe 208 along all three directions of space. Stated differently, the polarizabilities of the principal axes (e.g., a single large longitudinal polarizability and two smaller, lateral polarizability) of the pipe 208 may be determined based on the 3D geometry of the X-axis transmitter 204A, the Y-axis transmitter 204B, the Z-axis transmitter 204C, and respective receiver coils 116, as discussed in further detail below. The data generated by the polarizability of the pipe may be used to characterize physical attributes of the pipe 208, such as pipe diameter, wall thickness, and material composition.

It is to be understood that, while embodiments of the present disclosure are discussed below with reference to metal pipes, the embodiments of the present disclosure are not limited to metal pipes, and may be used or performed with respect to buried cables containing a conductive element (e.g., an element capable of inductively responding to EM fields), or more broadly to other underground conductive and/or magnetic elements. For example, the conductive element may be or comprise metallic sheathing around an underground cable (e.g., fiber optic cable). Such metallic sheathing may be detected and classified in accordance with embodiments of the present disclosure. Other non-limiting examples of conductive elements that can be detected and classified include gas lines, water lines, sewer lines, electrical lines, fiber optic cables, cooling pipes, drainage pipes, metallic objects, structural metal objects, combinations thereof, appurtenances or other components of the underground conductive elements (e.g., pipe valves, other asymmetrical objects, etc.), and the like. Furthermore, embodiments of the present disclosure are not limited to contexts with subterranean, man-made objects, and may include, for example, conductive fluids in non-metallic conduits. More generally, embodiments of the present disclosure cover contexts where there is a contrast in electrical conductivity and/or magnetic permeability between a background media and a monolithic object, where the contrast is sufficient to support eddy currents or magnetism. Similarly, an object with significantly lower conductivity than surrounding media may also be identified and/or classified using aspects of the present disclosure (e.g., an air pipe in seawater).

The EM induction system 100 may comprise one or more receiver coils 116. The receiver coils 116 may be or comprise air-cored induction coils, induction coils, solenoids, ferromagnetic material, combinations thereof, and/or the like capable of receiving, capturing, or measuring secondary magnetic fields created by the eddy currents in the metal object. In some embodiments, there may be an individual receiver coil 116 for each of the X-axis, Y-axis, and Z-axis directions. In other embodiments, the individual receiver coils 116 may include additional or alternative numbers of coils (e.g., two receiver coils, four receiver coils, six receiver coils, etc.). In some embodiments, the individual receiver coils 116 may be orthogonally disposed, while in other embodiments, any one or more receiver coils 116 (up to and including all receiver coils) may be non-orthogonal to one another.

The EM induction system 100 may include transmitter electronics 108 and receiver electronics 112. The transmitter electronics 108 may include electronics (e.g., processors, memories, models, algorithms, etc.) that can be used to control or operate the transmitter coils 104. Similarly, the receiver electronics 112 may be or comprise electronics that can be used to control the receiver coils 116. In some embodiments, the receiver electronics 112 and the receiver coils 116 may share one or more electronics (e.g., a processor). In some embodiments, the processor or a single controller may control any one or more components of the transmitter electronics 108 and/or the receiver electronics 112.

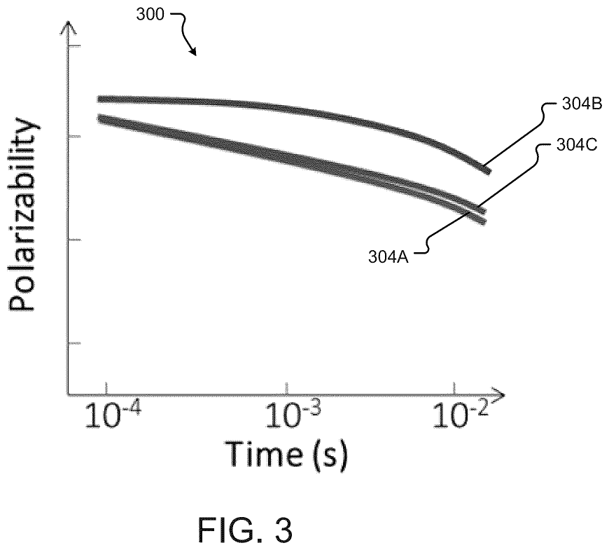

FIG. 3 illustrates an overall pipe response deconstructed into principal components according to at least one embodiment of the present disclosure. The graph 300 shows polarizability of the pipe as a function of time. The graph 300 may depict an X-axis polarizability 304A, a Y-axis polarizability 304B, and a Z-axis polarizability 304C. The X-axis polarizability 304A may correspond to the polarizability of the pipe 208 in the X-axis direction based on the eddy currents created by the magnetic field generated by the X-axis transmitter 204A. Similarly, the Y-axis polarizability 304B and the Z-axis polarizability 304C may be the respective polarizability of the pipe 208 in the Y-axis and Z-axis directions based on electrical currents created by the magnetic fields generated by the Y-axis transmitter 204B and the Z-axis transmitter 204C. However, the coordinate frame created by the X-axis, Y-axis, and Z-axis directions does not need to align with the coordinate frame created by directions associated with the X-axis polarizability 304A, Y-axis polarizability 304B, and Z-axis polarizability 304C. In other words, the principal axes of the pipe 208 do not necessarily need to align with the principal axes of the transmitter coils 104. In some embodiments, the X-axis polarizability 304A and the Z-axis polarizability 304C may be similar in shape, decay, and/or magnitude of polarizability due to the relative smaller lateral polarizability of the pipe 208. The graph 300 may also depict a third polarizability larger in magnitude with a longer time for polarizability to decrease, which may represent the component along the longitudinal direction of the pipe 208 (here, corresponding to the Y-axis direction). The different shape of the Y-axis polarizability 304B may be caused by the increased magnetization of the pipe 208 along this axis, resulting in a stronger secondary magnetic field generated by the eddy currents.

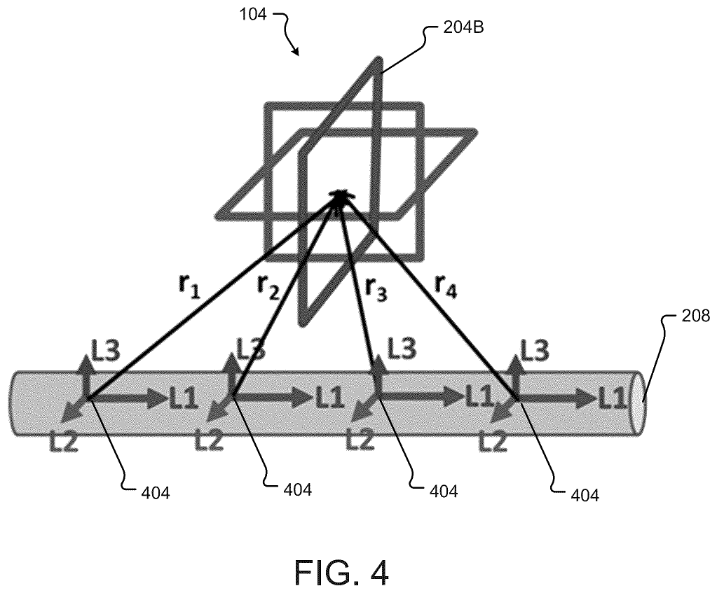

FIG. 4 illustrates a dipole model of a pipe in accordance with at least one embodiment of the present disclosure. The EM induction system 100 may be configured to deconstruct the eddy current response of the pipe 208 through geophysical inversion of the data, which may yield information about the three-dimensional (3D) location of the pipe 208. For example, the EM induction system 100 may use an a priori model of the eddy current response and determine a set of predicted eddy current responses. The predicted eddy currents may then be compared to the measured eddy current response, and the model may be updated based on the error (e.g., difference) between the measured data and the predicted data. The model may be iteratively updated until the a priori model prediction matches the measured eddy current response. The location of the pipe 208 may then be determined based on the known parameters of the a priori model. While an a priori model is discussed herein, the type of model used in the geophysical inversion is in no way limited. Non-limiting examples of the model include stochastic models (e.g., Monte Carlo models, Markov Chain models, etc.), deterministic models (e.g., Newton's Algorithm, Steepest Descent, Quadratic Programming, etc.), and the like. In some embodiments, a linear magnetic dipole model may be applied to predict the response of the pipe 208 to the transmitter fields. The model may represent the pipe 208 as a line of equally spaced and equivalent (in magnitude and direction) magnetic dipoles 404. The magnetic dipoles 404 may include orthogonal dipoles L1, L2, and L3 representative of the polarization experienced by the pipe 208 when the magnetic field generated by the transmitter coils 104 impinges upon the surface of the pipe 208. The magnetic field interacts with each of the orthogonal dipole axes. As shown in FIG. 4, the L1 dipole may have the strongest interaction (illustrated as the longest arrow L1), and the L2 and L3 dipoles, while having weaker interactions, will also create polarization.

When the transmitter coils 104 generate the magnetic field, the magnetic field may energize the pipe 208, and each segment of the pipe 208 (represented by the magnetic dipoles 404) may be polarized according to the projection of the magnetic field onto the corresponding magnetic dipoles 404. The model data may be processed (e.g., using an iterative inversion process), and the processed data may be output and compared with the data collected by the EM induction system 100. In other words, the model of an expected electromagnetic response from the pipe 208 may be compared to the actual data collected, with the model being iteratively updated until the model matches the actual data. In some embodiments, the comparison may be based on a threshold, such that the iterative process terminates when the model is within the threshold (e.g., the model and the actual data are different by 0.5%, 1%, 2%, 5%, etc.). Based on the comparison, the location, orientation, and/or electromagnetic polarizabilities of the pipe can be determined. Furthermore, one or more parameters of the pipe may be determined. Examples of pipe parameters include, but are no way limited to, pipe diameter, wall thickness, and material composition.

In some embodiments, the material composition of the pipe may be determined using the ratio of the polarizabilities and the decay rate of the polarizability of the pipe. For example, pipes made of ferrous materials (e.g., steel, cast iron, other iron-containing materials, etc.) experience magnetization from the transmitter fields in addition to the formation of the eddy currents. The magnetization of the pipe prolongs the decay of the eddy currents and creates the greatest effect when the pipe is polarized longitudinally. Such ferrous pipes may produce one large primary polarizability along the longitudinal axis of the pipe, and two smaller and approximately equal second and third polarizability in the first and second lateral axis directions, respectively.

Pipes made of non-ferrous materials (e.g., copper, lead, aluminum, brass, etc.) may experience only eddy currents in response to the transmitter field. In other words, the non-ferrous materials do not experience magnetization from the transmitter EM field. The eddy current response may also be greatest along the lateral axes of the pipe since such axes provide the greatest surface area. Therefore, pipes made from non-ferrous materials, such as copper and lead pipes, produce two large and approximately equal polarizabilities in the lateral directions of the pipe, and one smaller polarizability along the longitudinal axis of the pipe. For non-ferrous pipes, the rate of the eddy current and polarizability decays is proportional to the conductivity of the material. Materials with a higher conductivity will produce a longer decay period. As an example, copper is about an order of magnitude greater in conductivity than lead, resulting in lead pipe polarizabilities that decay significantly faster than those of copper pipes. In some embodiments, the pipe may comprise both ferrous and non-ferrous materials, with a polarizability of such a pipe falling between the polarizability of a pipe made from non-ferrous materials and a pipe made from ferrous materials. Embodiments of the present disclosure may identify the material composition of the pipe by calculating a ratio of the polarizabilities and the decay rate of the polarizability of the pipe to model data to determine the composition of the pipe. Such a procedure of identifying the pipe composition may be similar to that used to identify purely ferrous pipes or purely non-ferrous pipes, and enables embodiments of the present disclosure to identify the material composition of the pipe regardless of whether the pipe is made from a ferrous material, a non-ferrous material, or a mixture of both ferrous and non-ferrous materials.

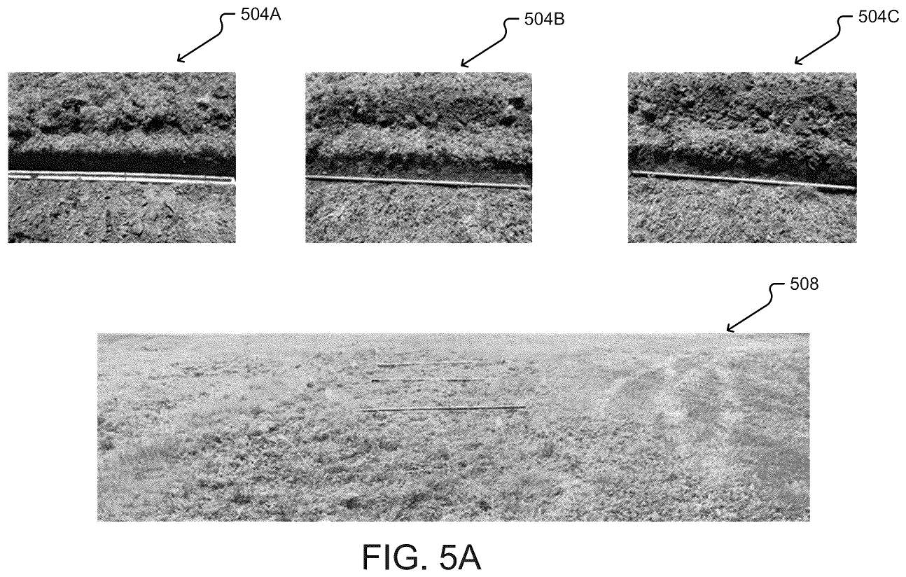

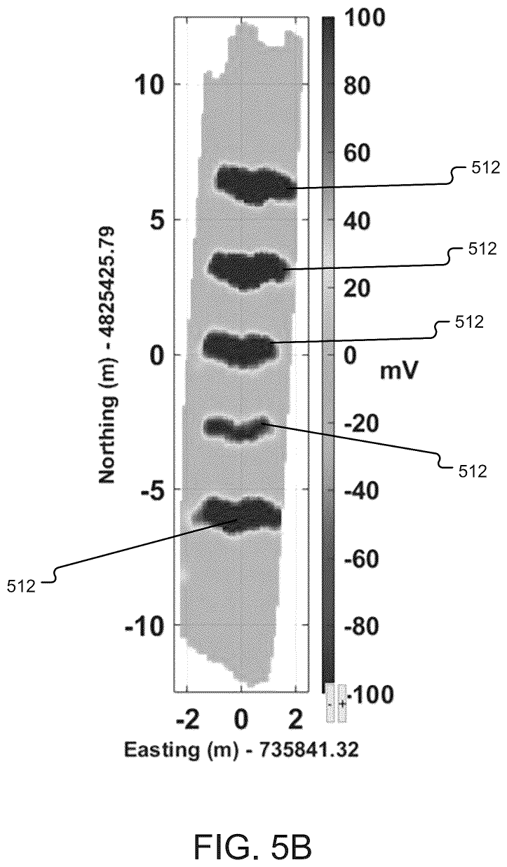

FIG. 5A illustrates a testbed 508 for determining the material composition of pipes according to at least one embodiment of the present disclosure. The testbed may include a row of pipe segments buried below the ground surface. The testbed 508 may include lead pipes 504A, copper pipes 504B, and steel pipes 504C. The pipes may be the same in dimensionality (e.g., diameter, wall thickness, length, etc.), and may vary only by material composition. The EM induction system 100 may then be used to survey the area, identify the location of the pipes, and use the data to determine the composition of the pipes. The data may appear as illustrated in FIG. 5B, with the spikes 512 in mV corresponding to electromagnetic anomalies. The regions may be used to select data for forming the dipole model shown in FIG. 4.

In some embodiments, the inverted polarizabilities may be used to determine material composition by comparing the inverted polarizabilities to a library of set polarizabilities obtained for each pipe. High confidence matches to the library may indicate proper material classification. For instance, a subterranean pipe of unknown composition may be compared to a steel library, a copper library, and a lead library. The unknown composition may have a 56% similarity with the steel library, a 70% similarity with the copper library, and a 98% similarity with the lead library, which may indicate that the subterranean pipe is made of lead. In embodiments where pre-determined libraries are absent or cannot be accessed, quantitative metrics such as polarizability decay rate and symmetry can be used to estimate material composition.

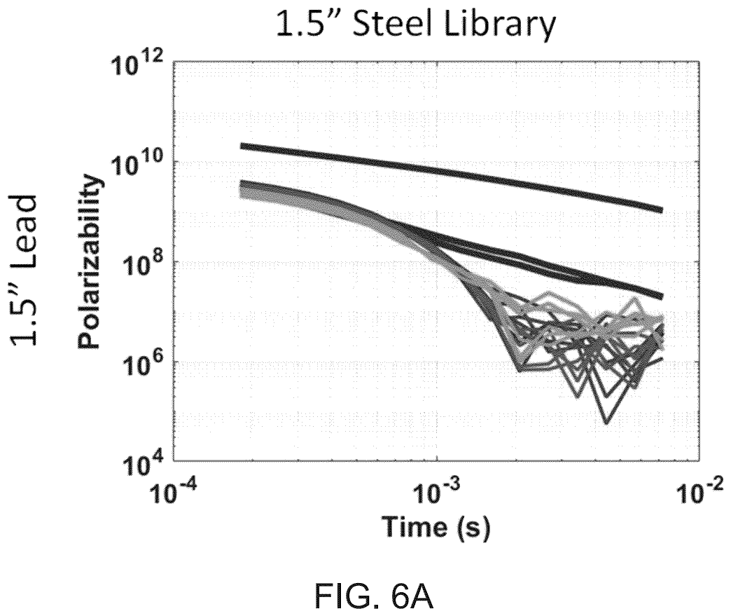

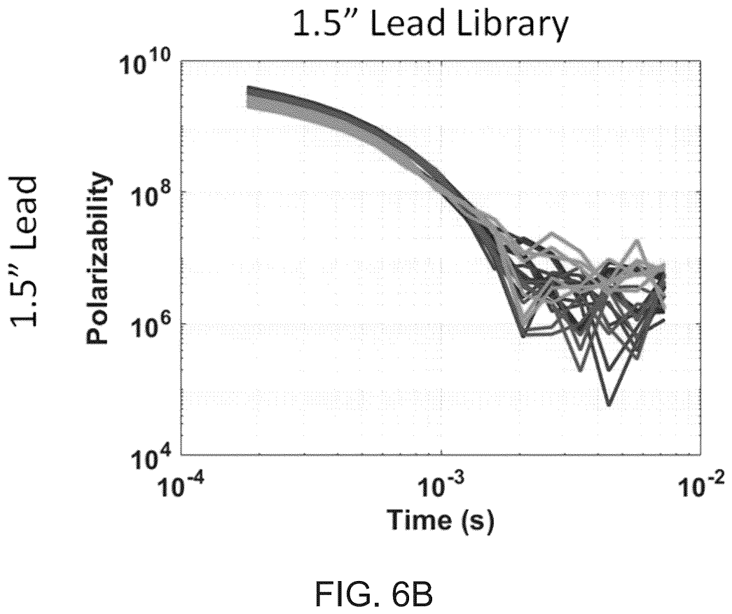

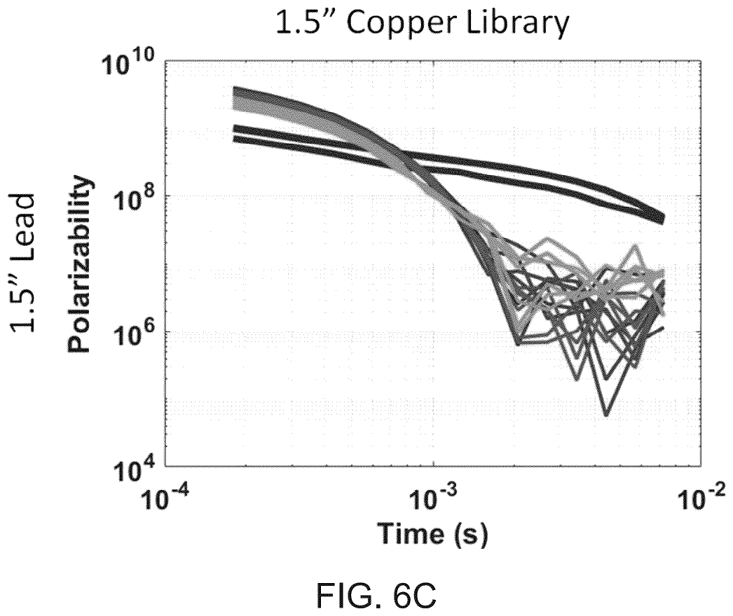

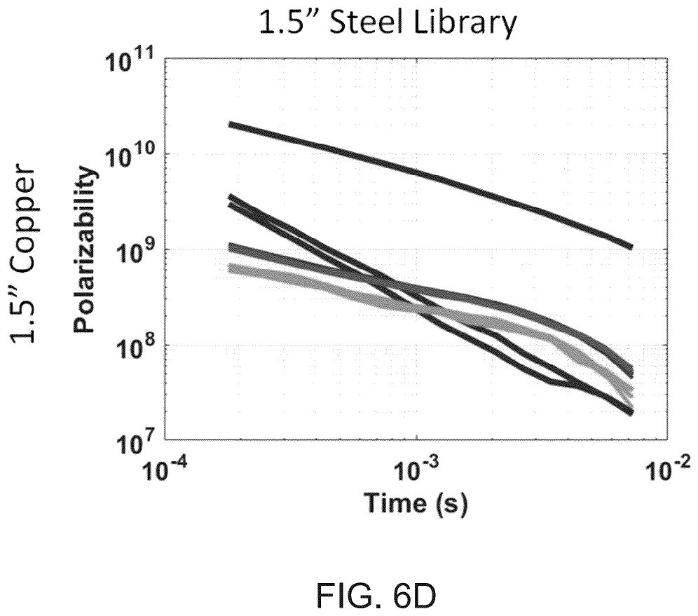

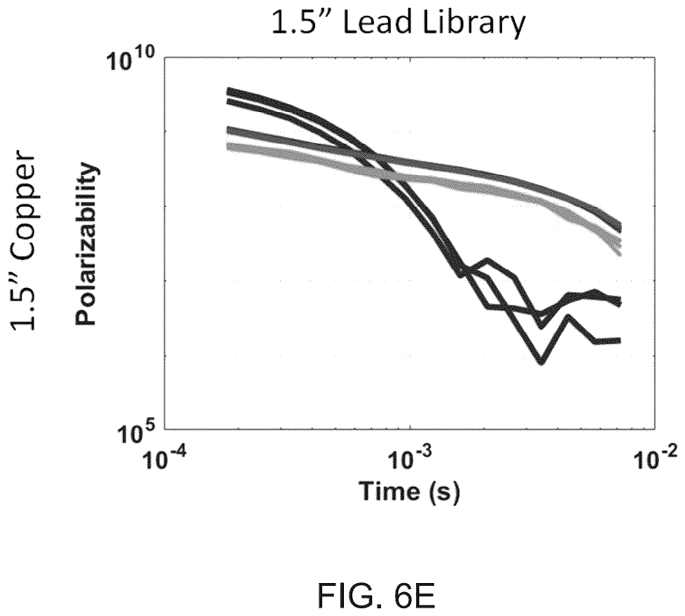

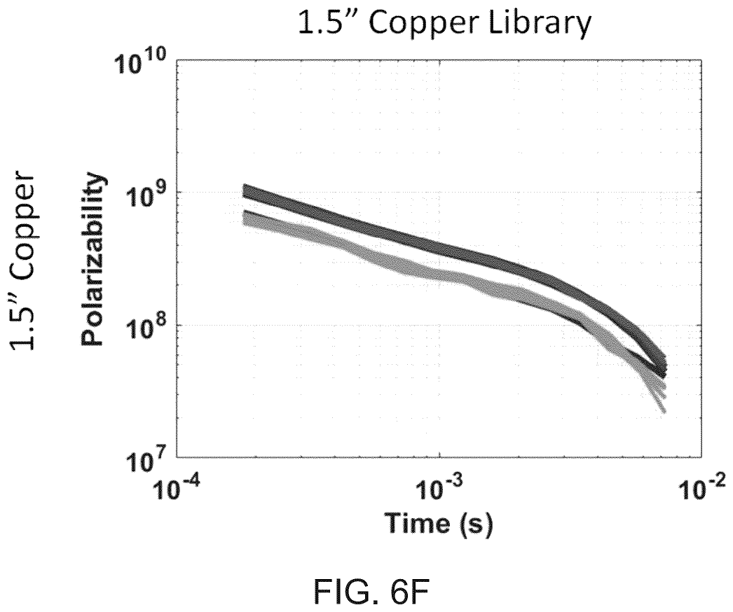

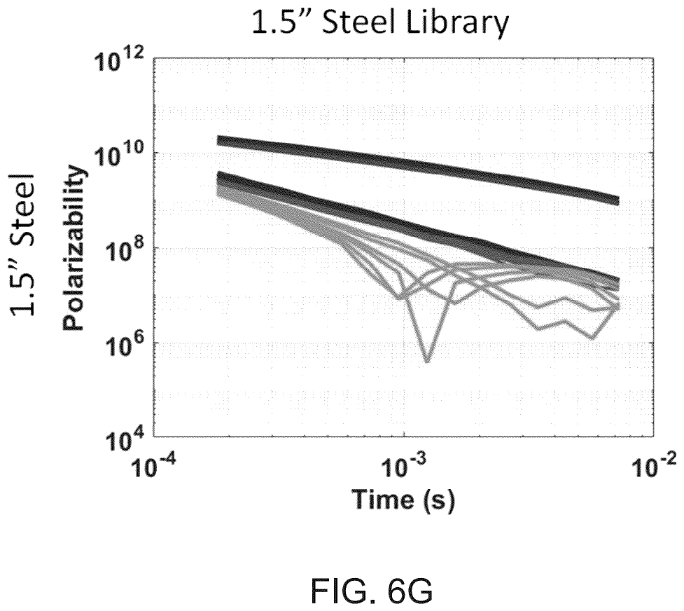

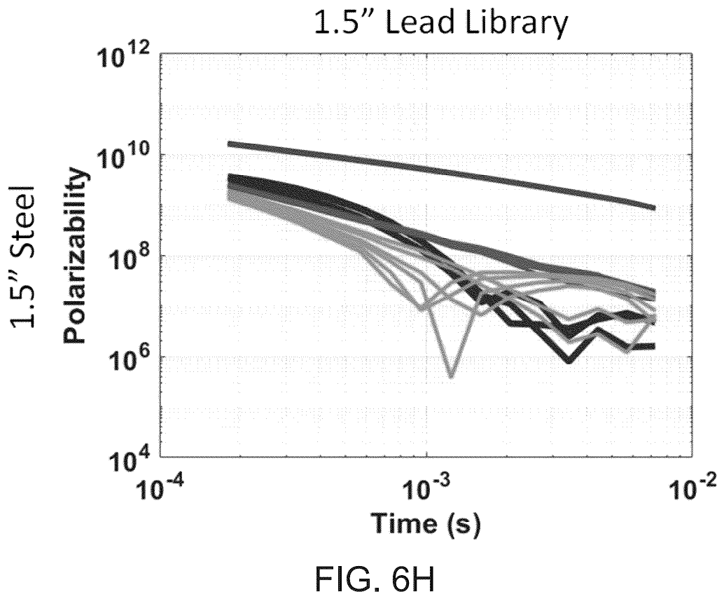

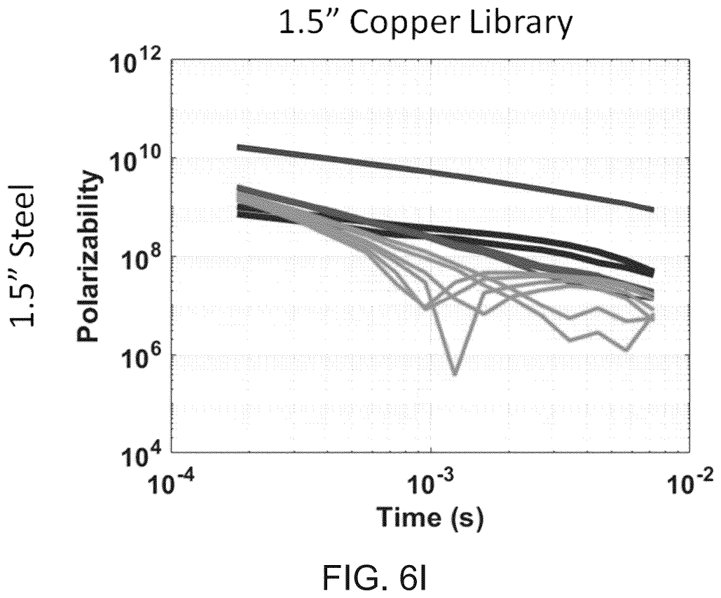

As illustrated in FIGS. 6A-6I, libraries for each pipe may be created by averaging polarizabilities from several measurements over each pipe. The library data can be created or acquired by using test items (e.g., a pipe) on or beneath the ground surface, to create a collection of ideal or typical polarizations associated with a range of pipe parameters (e.g., diameter, length, pipe thickness, material composition, etc.). In some embodiments, the libraries have high signal-to-noise ratios. After the libraries are established, the libraries data may be used to analyze survey data. Each survey pass over a pipe may produce several measurements of the electromagnetic response in the pipe that may be used to obtain polarizabilities. As seen in FIGS. 6A-6I, survey data (shown in red, blue, and green) may be compared to the library polarizabilities (shown in black) for each pipe type. As shown in FIGS. 6A-6C, survey data recorded in red, blue, and green is compared to a steel, lead, and copper library, respectively. The library values for the polarizability are shown in black. As can be seen, the polarizability values of the surveyed pipe do not match the steel or copper libraries (see respective FIGS. 6A, 6C), but closely matches the lead library (see FIG. 6B). As a result, the surveyed pipe may be classified as a lead pipe. FIGS. 6D-6F show survey data plotted against the steel, lead, and copper library, respectively. Here, the survey data closely matches the copper library (see FIG. 6F), and does not match the steel library (see FIG. 6D) or the lead library (see FIG. 6E). As a result, the surveyed pipe may be classified as a copper pipe. FIGS. 6G-6I show survey data plotted against the steel, lead, and copper library, respectively. The survey data closely matches the steel library (FIG. 6G), and does not match the lead library (FIG. 6H) or the copper library (FIG. 6I). As a result, the surveyed pipe may be classified as a steel pipe.

Additionally or alternatively, the material composition may be determined based on parameter space analysis, with the parameters derived from polarizabilities. One parameter may be a symmetry parameter, defined by the ratio of the primary polarizability and the secondary polarizability. In ferrous pipes (e.g., steel pipes), the symmetry value will be high because there is a large separation between the primary polarizability (e.g., the polarizability in the longitudinal direction of the pipe) and the secondary polarizability (e.g., the polarizability in the lateral direction of the pipe). In non-ferrous pipes (e.g., copper pipes, lead pipes, etc.), the symmetry value is smaller since the primary and secondary polarizabilities are similar in magnitude, since such polarizabilities correspond to the lateral axes of the pipe.

The second parameter may be the decay parameter, defined by the ratio of the primary polarizability late time value (e.g., the polarizability after the eddy currents begin to dissipate) to the primary polarizability early time value (e.g., the polarizability when the eddy currents begin to form or shortly after the eddy currents have formed), with the decay parameter representing a measure of the decay rate of the primary polarizability. In other words, the higher conductivity the pipe, the larger the decay value, since the polarizability over time does not fall off as quickly as with lower conductivity pipes. As such, ferrous pipes (e.g., steel pipes) and highly conductive pipes (e.g., copper pipes) will have larger decay parameters due to relatively long decay times as compared to lower conductivity, non-ferrous pipes (e.g., lead pipes) due to the rapid decay of the primary polarizability.

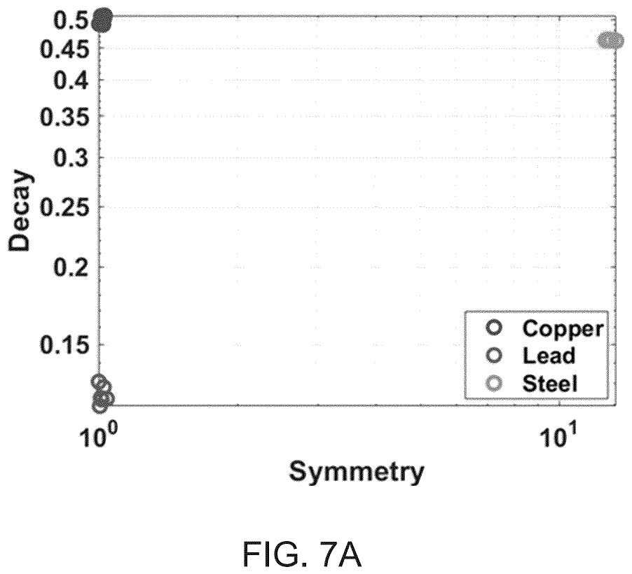

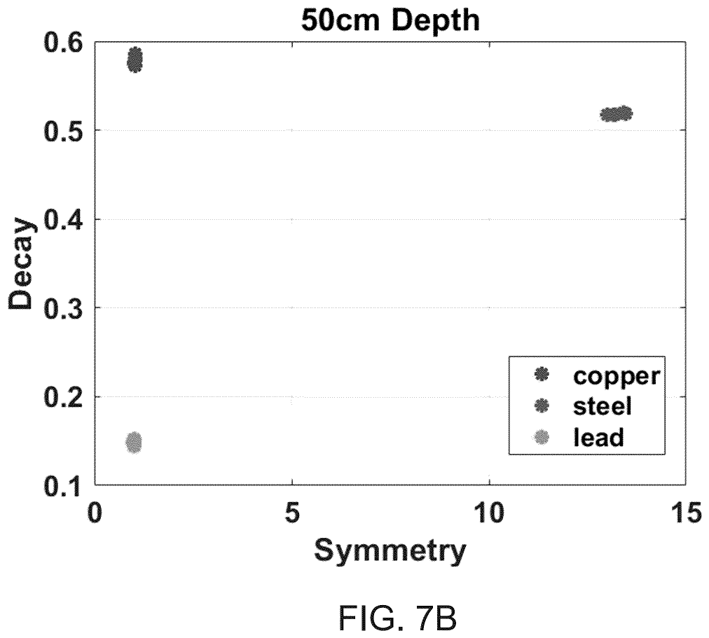

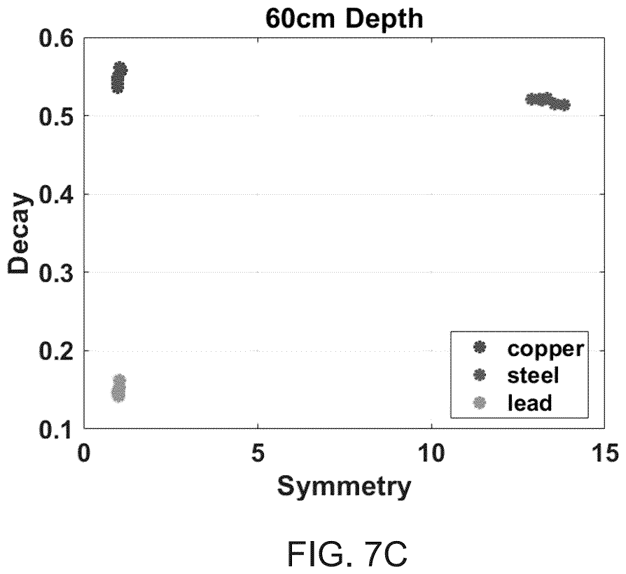

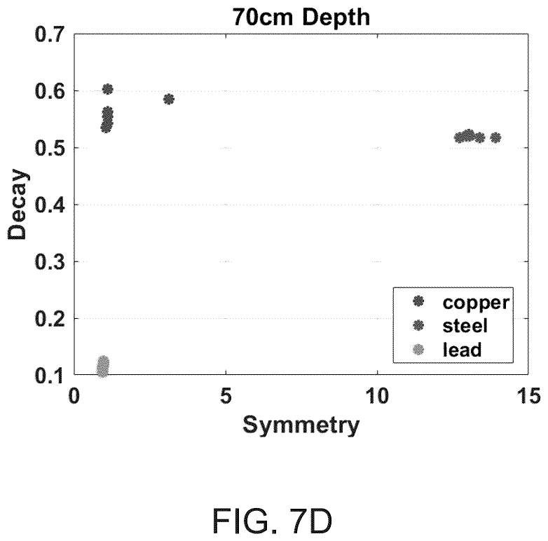

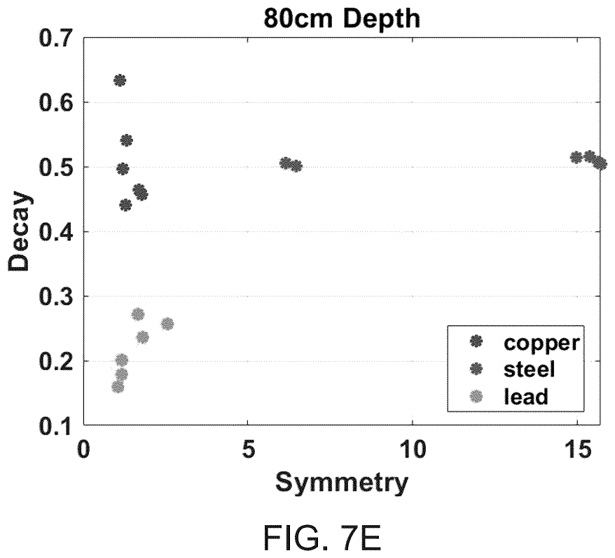

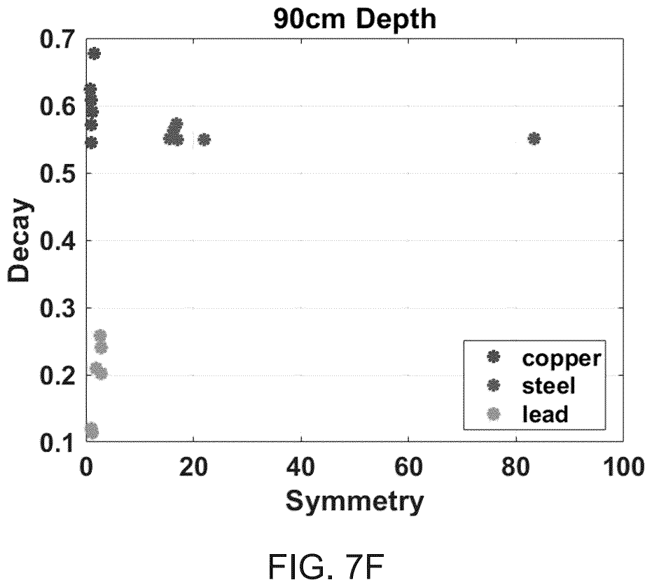

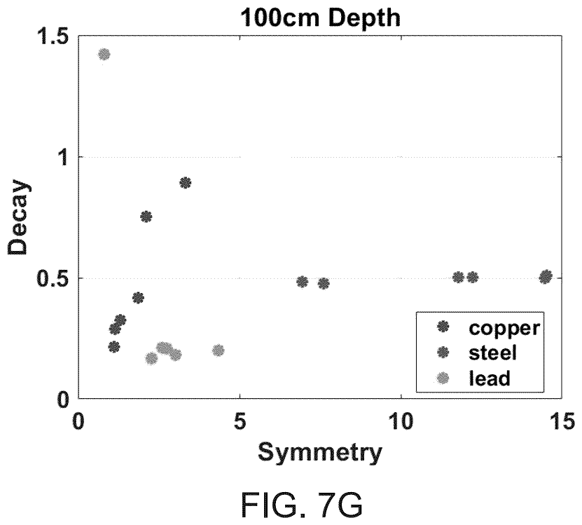

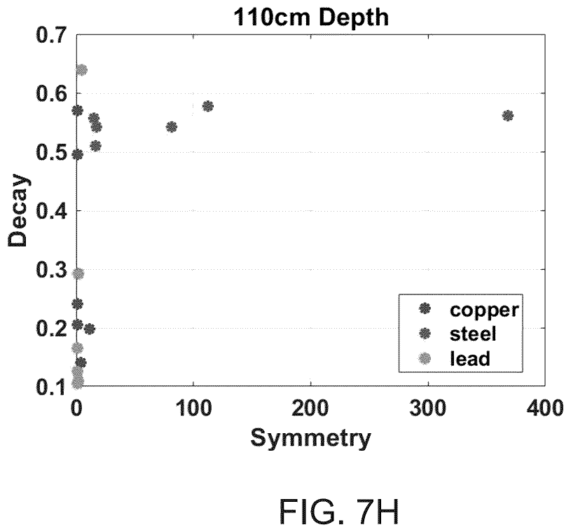

As shown in FIG. 7A, parameters from six measurements over each pipe are plotted against one another to illustrate the consistency of measurements for each pipe. As can be seen from the plot, lead has low decay and low symmetry parameters, copper has high decay and low symmetry parameters, and steel has high decay and high symmetry parameters, allowing for comparison and classification of data collected from a surveyed pipe to identify the material composition thereof by comparing the collected data to the plotted decay and symmetry parameters. FIGS. 7B-7H illustrate additional data collected at various pipe depths below the ground surface. More specifically, FIG. 7B shows data collected at a pipe depth of 50 centimeters (cm), FIG. 7C shows data collected at a pipe depth of 60 cm, FIG. 7D shows data collected at a pipe depth of 70 cm, FIG. 7E shows data collected at a pipe depth of 80 cm, FIG. 7F shows data collected at a pipe depth of 90 cm, FIG. 7G shows data collected at a pipe depth of 100 cm, and FIG. 7H shows data collected at a pipe depth of 110 cm.

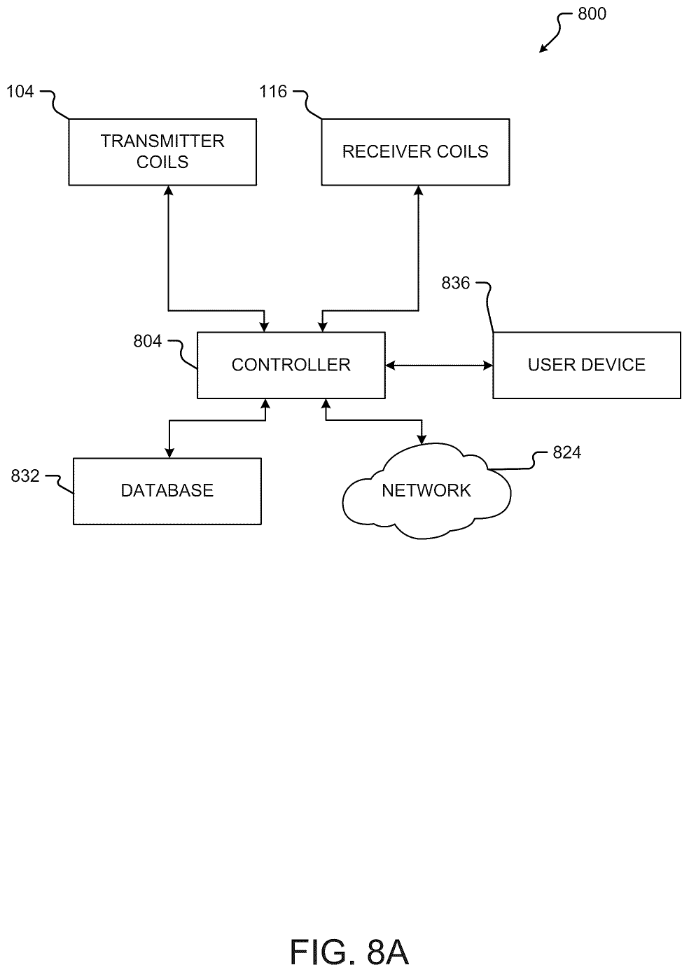

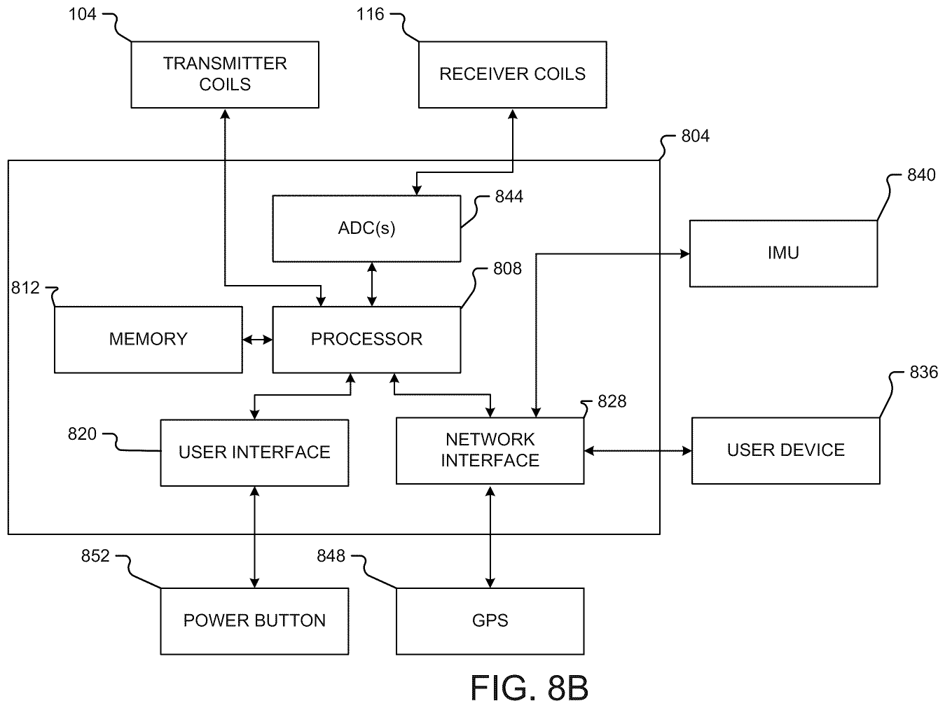

Turning to FIGS. 8A-8B, aspects of a system 800 are shown in accordance with embodiments of the present disclosure. The system 800 may be used in conjunction with the EM induction system 100 to receive data, process data, facilitate use of the EM induction system 100, combinations thereof, and/or the like. The system 800 may include a controller 804, a communication network 824, and a database 832. In some embodiments, the system 800 may be an aspect or component of the EM induction system 100 (e.g., the system 800 provides the electrical and/or mechanical control aspects of the system 800 enabling use of the EM induction system 100).

The controller 804 comprises a processor 808, a memory 812, a user interface 820, a network interface 828, and one or more analog to digital converters (ADCs) 844. Controllers according to other embodiments of the present disclosure may comprise more or fewer components than the controller 804. The controller 804 may communicate with one or more other components using the network interface 828, such as a user device 836, an inertial measurement unit (IMU) 840, a Global Positioning System (GPS) 848 (or components thereof), and/or a power button 852. The controller 804 may also communicate with cloud resources such that some of the processing described herein is performed in the cloud with results of that processing returned to the controller 804, for example, to be displayed to a user.

The processor 808 may correspond to one or more computer processing devices. For example, the processor 808 may be provided as silicon, an Application-Specific Integrated Circuit (“ASIC”), as a Field Programmable Gate Array (“FPGA”), any other type of Integrated Circuit (“IC”) chip, a collection of IC chips, and/or the like. In some embodiments, the processor 808 may be provided as a Central Processing Unit (“CPU”), a graphics Processing Unit (GPU), a microprocessor, and/or a plurality of microprocessors that are configured to execute the instructions sets stored in memory 812. Upon executing the instruction sets stored in memory 812, the processor 808 enables various communications, calculations, comparison, and/or interaction functions of the EM induction system 100 and/or the system 800, and may provide an ability to establish and maintain communication sessions between communication devices over the communication network 824 when specific predefined conditions are met. The processor 808 may be embodied as a virtual processor(s) executing on one or more physical processors. The execution of a virtual processor may be distributed over a number of physical processors or one physical processor may execute one or more virtual processors. Virtual processors are presented to a process as a physical processor for the execution of the process while the specific underlying physical processor(s) may be dynamically allocated before or during the execution of the virtual processor wherein the instruction stack and pointer, register contents, and/or other values maintained by the virtual processor for the execution of the process are transferred to another physical processor(s). As a benefit, the physical processors may be added, removed, or reallocated without affecting the virtual processors execution of the processes. For example, processor 808 may be one of a number of virtual processors executing on a number of physical processors (e.g., “cloud”, “farm”, array, etc.) and presented to the processes herein as a dedicated processor. Additionally or alternatively, the physical processor(s) may execute a virtual processor to provide an alternative instruction set as compared to the instruction set of the virtual processor (e.g., an “emulator”). As a benefit, a process compiled to run a processor having a first instruction set (e.g., Virtual Address Extension (“VAX”)) may be executed by a processor executing a second instruction set (e.g., Intel® 9xx chipset code) by executing a virtual processor having the first instruction set (e.g., VAX emulator).

The processor 808 may correspond to one or many computer processing devices. Non-limiting examples of a processor include a microprocessor, an IC chip, a General Processing Unit (“GPU”), a CPU, or the like. Examples of the processor 808 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, ARM® Cortex™-M processors, ARM® Cortex-A and ARIV1926EJS™ processors, other industry-equivalent processors, and may perform computational functions using any known or future-developed standard, instruction set, libraries, and/or architecture. The processor 808 may be a multipurpose, programmable device that accepts digital data as input, processes the digital data according to instructions stored in its internal memory, and provides results as output. The processor 808 may implement sequential digital logic as it has internal memory. As with most microprocessors, the processor 808 may operate on numbers and symbols represented in the binary numeral system.

The memory 812, or storage memory, may correspond to any type of non-transitory computer-readable medium. In some embodiments, the memory 812 may comprise volatile or non-volatile memory and a controller for the same. Non-limiting examples of the memory 812 that may be utilized in the EM induction system 100 and/or the system 800 may include Random Access Memory (“RAM”), Read Only Memory (“ROM”), buffer memory, flash memory, solid-state memory, or variants thereof. Any of these memory types may be considered non-transitory computer memory devices even though the data stored thereby can be changed one or more times. The memory 812 may be used to store information about communications, identifications, conditional requirements, times, authentication, authorization, compliance, history, and/or the like. In some embodiments, the memory 812 may be configured to store rules and/or the instruction sets depicted in addition to temporarily storing data for the processor 808 to execute various types of routines or functions. Although not depicted, the memory 812 may include instructions that enable the processor 808 to store data into a memory storage device and retrieve information from the memory storage device. In some embodiments, the memory storage device or the data stored therein may be stored internal to the EM induction system 100 and/or the system 800 (e.g., within the memory 812 of the system 800 rather than in a separate database) or in a separate server.

The user interface 820 may correspond to any type of input and/or output device, or combination thereof, that enables a user to interact with the EM induction system 100 and/or the system 800 (or components thereof). As can be appreciated, the nature of the user interface 820 may depend upon the nature of the EM induction system 100. Examples of the user interface 820 may include, but are in no way limited to, user interface hardware and devices such as at least one touch-sensitive display elements, buttons, switches, keyboards, peripheral interface devices (e.g., mice, controller, joysticks, etc.) as described herein. It is an aspect of the present disclosure that one or more devices in the user interface 820 may provide an input that is interpreted by the processor 808 in controlling one or more components of the EM induction system 100 and/or the system 800.

The communication network 824 may comprise any type of known communication medium or collection of communication media and may use any type of protocols to transport messages between endpoints. The communication network 824 may include wired and/or wireless communication technologies. The Internet is an example of the communication network 824 that constitutes an Internet Protocol (“IP”) network consisting of many computers, computing networks, and other communication devices located all over the world, which are connected through many telephone systems and other means. Other examples of the communication network 824 include, without limitation, a standard Plain Old Telephone System (“POTS”), an Integrated Services Digital Network (“ISDN”), the Public Switched Telephone Network (“PSTN”), a Local Area Network (“LAN”), a Wide Area Network (“WAN”), a VoIP network, a Session Initiation Protocol (“SIP”) network, a cellular network, and any other type of packet-switched or circuit-switched network known in the art. In addition, it can be appreciated that the communication network 824 need not be limited to any one network type, and instead may be comprised of a number of different networks and/or network types. The communication network 824 may comprise a number of different communication media such as coaxial cable, copper cable/wire, fiber-optic cable, antennas for transmitting/receiving wireless messages, optical/infrared, and combinations thereof.

The network interface 828 provides the controller 804 with the ability to send and receive communication packets or the like over the communication network 824. The network interface 828 may be provided as a network interface card (“NIC”), a network port, a modem, drivers for the same, and the like. Communications between the components of the EM induction system 100 and/or the system 800 and other devices connected to the communication network 824 may flow through the network interface 828. In some embodiments, examples of a suitable network interface 828 include, without limitation, an antenna, a driver circuit, an Ethernet port, a modulator/demodulator, an NIC, an RJ-11 port, an RJ-45 port, an RS-232 port, a USB port, etc. The network interface 828 may include one or multiple different network interfaces depending upon whether the EM induction system 100 and/or the system 800 is connecting to a single communication network or multiple different types of communication networks. For instance, the EM induction system 100 and/or the system 800 may be provided with both a wired network interface and a wireless network interface without departing from the scope of the present disclosure. In such embodiments, the network interface 828 may enable wired and/or wireless communication. In some embodiments, the EM induction system 100 and/or the system 800 may include different communications ports that interconnect with various input/output lines.

The ADCs 844 convert analog signals to digital signals. The ADCs 844 may be or comprise one or more integrated circuits (ICs) including one or more metal-oxide-semiconductors (MOS). The ADCs 844 may receive analog measurements, readings, or other data from the transmitter coils 104 and/or receiver coils 116. The ADCs 844 may convert the received analog signals into digital signals, and pass the digital signals to the processor 808 for further processing. The ADCs 844 may include additional processing capabilities (e.g., digital signal processors (DSPs) and the like) and may filter, sort, or otherwise package the digital signals before sending the digital signals to the processor 808. Such organizing of the digital signal may reduce the computational time of the processor 808. In some embodiments, the controller 804 may additionally include one or more digital to analog converters (DACs) that convert digital signals into analog signals.

The database 832 may be or comprise any tangible storage and/or transmission medium that participates in providing instructions to a processor for execution. Such a medium may take many forms, including but not limited to, non-volatile media, volatile media, and transmission media. Non-volatile media include, for example, NVRAM, or magnetic or optical disks. Volatile media include dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable medium is configured as a database (e.g., the database 832), it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The controller 804 may communicate with the IMU 840. While a single IMU is discussed herein, it is to be understood that a plurality of IMUs may be present in the system 800. The IMU 840 may be or comprise an accelerometer, a gyroscope, combinations thereof, and the like capable of detecting movement of a device or object to which the IMU 840 is attached. For example, the IMU 840 may be disposed on or near one of the transmitter coils 104 or one of the receiver coils 116, such that movement of the transmitter coil 104 or the receiver coil 116 is detected by the IMU 840. The IMU 840 may then send measurements or other data describing movement of the transmitter coil 104 or the receiver coil 116 to the controller 804 over the network interface 828. The received data may be processed by the processor 808 to determine whether the movement of the transmitter coil 104 or the receiver coil 116 is acceptable, planned, or otherwise permitted (e.g., whether the movement occurred because a user directed the transmitter coil 104 or the receiver coil 116 to move, or whether the movement occurred accidentally or unexpectedly). When the movement is unexpected, the processor 808 may generate an alert send to the user device 836 to inform the user that the transmitter coil 104 or the receiver coil 116 is mispositioned. Additionally or alternatively, the processor 808 may send the alert to the GPS 848, and the GPS 848 may augment the GPS positioning output (e.g., the measured latitude, longitude, and/or elevation) based on the alert to indicate the determined roll, pitch, and/or yaw of the system. In other words, while the GPS 848 may output measurements or other determinations of the location and elevation above sea level of the EM induction system 100, the processor 808 may use the data generated by the IMU 840 to correct the GPS measurements to account for effects of a sloped ground, of an operator tilting the EM induction system 100, combinations thereof, and the like.

The GPS 848 may include one or more sensors configured to utilize a satellite-based navigation system including a network of navigation satellites capable of providing geolocation and time information to a user (e.g., via a user device 836). Examples of the sensors as described herein may include, but are not limited to, at least one of Garmin® GLO™ family of GPS and GLONASS combination sensors, Garmin® GPS 15x™ family of sensors, Garmin® GPS 16x™ family of sensors with high-sensitivity receiver and antenna, Garmin® GPS 18x OEM family of high-sensitivity GPS sensors, Dewetron DEWE-VGPS series of GPS sensors, GlobalSat 1-Hz series of GPS sensors, other industry-equivalent navigation sensors and/or systems, and may perform navigational and/or geolocation functions using any known or future-developed standard and/or architecture. The GPS 848 may enable the user to determine the geolocation of the EM induction system 100, such as when the EM induction system 100 is coupled with or part of a vehicle or other mobile device. In some embodiments, the GPS 848 may pass along the geolocation information through the network interface 828 to the user device 836.

The power button 852 may permit the user to activate or deactivate the EM induction system 100, or any other component of the EM induction system 100 or the system 800 discussed herein. The power button 852 may be disposed on the user interface 820 and, when activated, may send an electrical signal to the processor 808. The processor 808 may process the signal and turn on or off the appropriate component. In some embodiments, one or more settings associated with the EM induction system 100 or the system 800 may be adjustable (e.g., using the user interface 820) such that the power button 852 enables or disables different components of the EM induction system 100 or the system 800 depending on the settings adjusted by the user. In some embodiments, the power button 852 may be a physical button, switch, or lever, while in other embodiments, the power button 852 may be a virtual rendering on a screen (e.g., on the user interface 820).

The user device 836 may be similar to or the same as the user interface 820, and may include, for example, hardware and devices such as at least one touch-sensitive display elements, buttons, switches, keyboards, screens, peripheral interface devices (e.g., mice, controller, joysticks, etc.) that enable the user to interact with the EM induction system 100 and/or the system 800. In some embodiments, the user may control the EM induction system 100 from the user device 836. In some embodiments, the user device 836 may be or comprise a personal computer, laptop, tablet, or the like capable of interacting with the EM induction system 100 and/or the system 800 through, for example, the network interface 828. In some embodiments, feedback from the EM induction system 100 (e.g., results as to whether a subterranean metal object is made of lead, copper, or steel) may be rendered to a display on the user device 836.

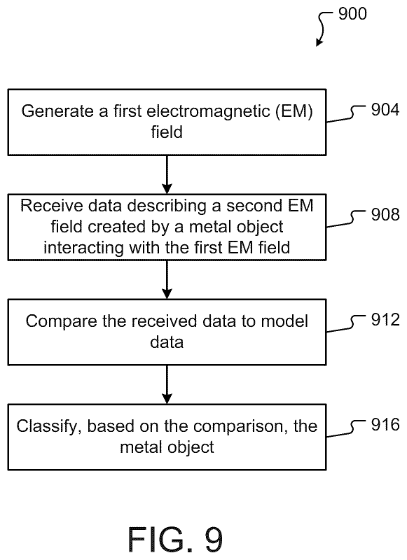

FIG. 9 depicts a method 900 that can be used, for example, to determine material composition of a subterranean metal object (e.g., a pipe).

The method 900 (and/or one or more steps thereof) may be carried out or otherwise performed, for example, by at least one processor. The at least one processor may be the same as or similar to the processor(s) 808 of the controller 804 described above. The at least one processor may be part of an EM induction system (e.g., an EM induction system 100). A processor other than any processor described herein may also be used to execute the method 900. The at least one processor may perform the method 900 by executing instructions stored in memory such as the memory 812. The instructions may correspond to one or more steps of the method 900 described below. The instructions may cause the processor to execute one or more algorithms.

The method 900 comprises generating a first EM field (step 904). The first EM field may be generated by one or more transmitter coils 104 that propagate through the ground to interact with a metal object in the ground. In some embodiments, the first EM field may be connected to a mobile system such as the EM induction system 100, such that the EM field can be moved as land is surveyed.

The method 900 also comprises receiving data describing a second EM field created by a metal object interacting with the first EM field (step 908). The impinging of the first EM field upon the metal object may create eddy currents in the metal object, generating the second EM field. The second EM field may be measured by the receiver coils 116, which may be connected to the EM induction system 100. In other embodiments, the receiver coils 116 may be positioned a first distance from the EM induction system 100. In some embodiments, the metal object may be a metal pipe.

The method 900 also comprises comparing the received data to model data (step 912). The model data may be data generated by impinging sample metal objects with the first EM field, and measuring the second EM field generated by the eddy currents of the metal object. For instance, the model data may comprise polarizability values for a range of metal pipes (e.g., steel pipes, copper pipes, lead pipes, etc.) that are compared to the received data. The comparison may include comparing the received data to model polarizability curves and determining how closely the received data matches the model polarizability curves. Additionally or alternatively, the comparing may include determining a symmetry parameter value (defined as the ratio between a primary polarizability of the metal pipe and a second polarizability of the metal pipe) and a decay parameter value (defined as the ratio of the primary polarizability of the metal pipe at a late time value after the eddy currents have begun to decay with the primary polarizability of the metal pipe at an early time value as the eddy currents form or just after the eddy currents form). The determined symmetry parameter values and decay parameter values of the metal pipe may then be compared to model symmetry and decay parameter values of pipes of known compositions.

In some embodiments, the model data and/or information derived therefrom (e.g., the polarizability curves) may include information about an amount of impurity of the metal pipe or object. For example, the model data may include data associated with a certain amount of impurity (e.g., the metal pipe is 99% steel and 1% other materials, 98% steel and 2% other materials, 95% steel and 5% other materials, etc.), a certain amount of corrosion or oxidation (e.g., the metal pipe is 0.5% rust, 1% rust, 5% rust, 10% rust, 25% rust, etc.), and the like. In some embodiments, the amount of impurity, corrosion, oxidation, etc. may be expressed in terms of quantities, percentages, volumes, combinations thereof, and the like.

The method 900 also comprises classifying, based on the comparison of the received data to the model data, the metal object (step 916). In some embodiments, the comparison may include comparing the polarizability of the metal pipe with model polarizability of pipes with known material composition. For instance, the metal pipe polarizability may be compared to the polarizability of a steel pipe, the polarizability of a copper pipe, and the polarizability of a lead pipe. The metal pipe may then be classified as being made of the material of the model pipe whose polarizability curve the metal pipe most closely matches. For instance, a metal pipe that most closely matches the model polarizability of copper may be classified as a copper pipe. In some embodiments, the model data describing the amount of impurity, corrosion, oxidation, etc. may be incorporated into the model data and/or the polarizability curves. As an example, a first polarizability curve may be associated steel pipe with 30% rust, while a second polarizability curve may be associated with a steel pipe with 70% rust. The received data may be compared to each of these model data sets, and the processor 808 may determine that the received data most closely matches the second polarizability curve. As a result, the unknown pipe may be classified as a steel pipe with 70% rust.

Additionally or alternatively, the classification may include plotting the determined symmetry and decay parameter values of the metal pipe against the decay and symmetry values of model pipes of known composition. The metal pipe may then be classified based on the relative location on the plot of the metal pipe and the known symmetry and decay parameter values of the model pipes of known composition. For example, since steel pipes tend to have high symmetry and decay parameter values, copper pipes have a low symmetry parameter value and a high decay parameter value, and lead pipes have low symmetry and decay parameter values, a metal pipe with high symmetry parameter value and a high decay parameter value may be classified as a steel pipe, while a metal pipe with a low symmetry value and a low decay parameter value may be classified as a lead pipe.

Optionally, the system can overlay and output any one or more of the above results with a map, such as a topographical, satellite or other map, such that the locations, characteristics and classifications of the subterranean object can be visualized by, for example, a user.

The present disclosure encompasses embodiments of the method 900 that comprise more or fewer steps than those described above, and/or one or more steps that are different than the steps described above.

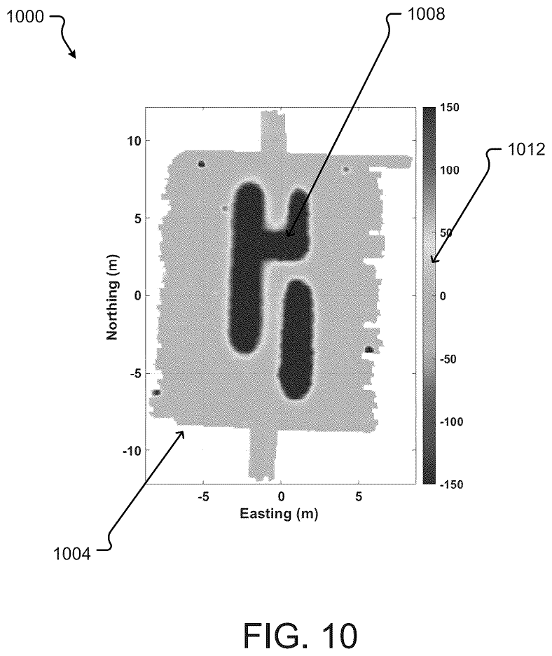

Turning to FIG. 10, an output graphic 1000 according to at least one exemplary embodiment of the present disclosure is depicted. The output graphic 1000 may be a visual representation of data 1004 generated by the EM induction system 100 and presented to a user (e.g., via a display such as a monitor). The output graphic 1000 also depicts pipe data 1008 (e.g., data that indicates that the pipe is present), with the X- and Y-axes indicating the coordinates (e.g., northing and easting) associated with the pipe. A scale 1012 may depict an overall induction response signal amplitude of data 1004, with a higher induction response corresponding to a greater likelihood that a pipe (or more generally, a metal object) is present. As can be seen in FIG. 10, the pipe data 1008 may have a high induction response (e.g., a value of 150 on the scale 1012), and may be depicted in dark red. The non-pipe data may have no induction response (e.g., a value of 0 on the scale 1012), and may be depicted in green.

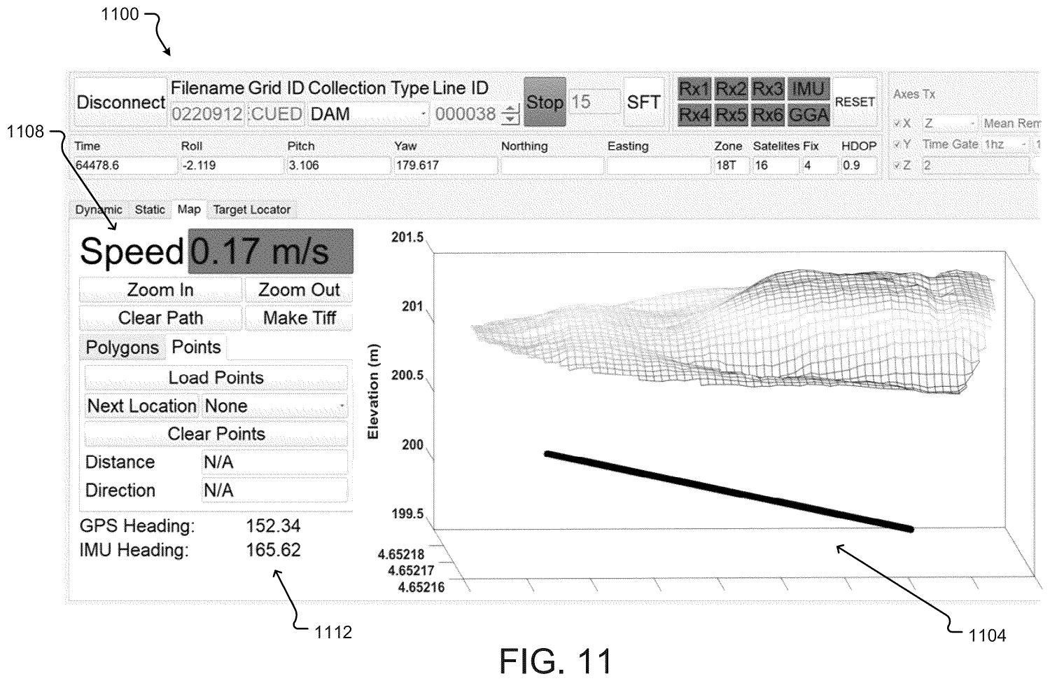

FIG. 11 illustrates a user interface 1100 according to at least one exemplary embodiment of the present disclosure. The user interface 1100 may be displayed to a user on a monitor or other display, and the user may be able to interact with the user interface 1100 (e.g., by touching the screen of the display). The user interface 1100 may display an elevation graph 1104 that provides elevation information containing the estimated 3D location of the pipe to the user. The user interface 1100 may also display speed information 1108, which may reflect the current speed of the EM induction system 100 (e.g., when the induction system is mounted to a mobile vehicle). The user interface 1100 may also display location information 1112 to the user, which may provide the user with GPS coordinates, the relative pitch, roll, and yaw of the EM induction system 100, combinations thereof, and the like. In some embodiments, the user interface 1100 may provide options for the user to record or save the information displayed on the user interface (e.g., to the database 832). In some embodiments, additional or alternative information may be displayed on the user interface 1100.

Any of the steps, functions, and operations discussed herein can be performed continuously and automatically.

The exemplary systems and methods of this disclosure have been described in relation to an EM induction system. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on a programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Example aspects of the present disclosure include:

An apparatus according to at least one embodiment of the present disclosure comprises: a processor; at least one electromagnetic (EM) transmitter coil that generates a first EM field; and a memory storing instructions thereon that, when executed by the processor, cause the processor to: receive data describing a measured second EM field generated by eddy currents in a metal object that interacts with the first EM field; compare the received data to model data; and classify, based on the comparing of the received data to the model data, the metal object.

Any of the aspects herein, wherein the at least one EM transmitter coil comprises a first EM transmitter coil that generates a first directional component of the first EM field, a second EM transmitter coil that generates a second directional component of the first EM field, and a third EM transmitter coil that generates a third directional component of the first EM field.

Any of the aspects herein, wherein the metal object includes a pipe, and wherein the received data include information about a primary polarizability, a secondary polarizability, and a tertiary polarizability of the pipe.

Any of the aspects herein, wherein the classifying of the metal object includes determining a pipe thickness, a pipe diameter, and a material composition of the pipe.

Any of the aspects herein, wherein the material composition of the pipe is determined by comparing at least one of the primary polarizability, the secondary polarizability, or the tertiary polarizability to one or more model data sets depicting polarizability of a steel pipe, a copper pipe, and a lead pipe.

Any of the aspects herein, wherein the one or more model data sets includes information about an amount of impurity of each of the steel pipe, the copper pipe, and the lead pipe.

Any of the aspects herein, wherein the amount of impurity includes a percentage of corrosion in each of the steel pipe, the copper pipe, and the lead pipe.

Any of the aspects herein, wherein determining the material composition of the pipe includes calculating a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

Any of the aspects herein, wherein determining the material composition of the pipe includes comparing the symmetry parameter value and the decay parameter value of the pipe to model symmetry parameter values and model decay parameter values of a steel pipe, a copper pipe, and a lead pipe.

An apparatus according to at least one embodiment of the present disclosure comprises: a processor; at least one electromagnetic (EM) transmitter coil that generates a first EM field; and a memory storing instructions thereon that, when executed by the processor, cause the processor to: receive data describing a measured second EM field generated by eddy currents in a metal object that interacts with the first EM field; and determine, based on the received data, a location of the metal object.

Any of the aspects herein, wherein the at least one EM transmitter coil comprises a first EM transmitter coil that generates a first directional component of the first EM field, a second EM transmitter coil that generates a second directional component of the first EM field, and a third EM transmitter coil that generates a third directional component of the first EM field.

Any of the aspects herein, wherein the metal object includes a pipe, and wherein the received data include information about a primary polarizability, a second polarizability, and a tertiary polarizability of the pipe.

Any of the aspects herein, wherein the metal object is disposed 50 centimeters (cm), 60 cm, 70 cm, 80 cm, 90 cm, 100 cm, or 110 cm below a ground surface.

Any of the aspects herein, wherein determining the location of the metal object comprises determining a location in 3D space.

Any of the aspects herein, wherein determining the location of the metal object comprises determining geolocation information about the metal object.

An apparatus according to at least one embodiment of the present disclosure comprises: a processor; at least one electromagnetic (EM) transmitter coil that generates a first EM field; and a memory storing instructions thereon that, when executed by the processor, cause the processor to: receive data describing a measured second EM field generated by eddy currents in a metal object that interacts with the first EM field; determine, based on the received data, a location of the metal object; compare the received data to model data; and classify, based on the comparing of the received data and the model data, the metal object.

Any of the aspects herein, wherein the at least one EM transmitter coil comprises a first EM transmitter coil that generates a first directional component of the first EM field, a second EM transmitter coil that generates a second directional component of the first EM field, and a third EM transmitter coil that generates a third directional component of the first EM field.

Any of the aspects herein, wherein the metal object includes a pipe, and wherein the received data include information about a primary polarizability, a secondary polarizability, and a tertiary polarizability.

Any of the aspects herein, wherein the classifying of the metal object includes determining a pipe thickness, a pipe diameter, and a material composition of the pipe.

Any of the aspects herein, wherein the material composition of the pipe is determined by comparing at least one of the primary polarizability, the secondary polarizability, or the tertiary polarizability to one or more model data sets depicting polarizability of a steel pipe, a copper pipe, and a lead pipe.

Any of the aspects herein, wherein the one or more model data sets includes information about an amount of impurity of each of the steel pipe, the copper pipe, and the lead pipe.

Any of the aspects herein, wherein the amount of impurity includes a percentage of corrosion in each of the steel pipe, the copper pipe, and the lead pipe.

Any of the aspects herein, wherein determining the material composition of the pipe includes calculating a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

Any of the aspects herein, wherein determining the material composition of the pipe includes comparing the symmetry parameter value and the decay parameter value of the pipe to model symmetry parameter values and model decay parameter values of a steel pipe, a copper pipe, and a lead pipe.

Any of the aspects herein, wherein the metal object is disposed 50 centimeters (cm), 60 cm, 70 cm, 80 cm, 90 cm, 100 cm, or 110 cm below a ground surface.

Any of the aspects herein, wherein determining the location of the metal object comprises determining a location in 3D space.

Any of the aspects herein, wherein determining the location of the metal object comprises determining geolocation information about the metal object.

A method according to at least one embodiment of the present disclosure comprises: generating a first electromagnetic (EM) field; receiving data describing a measured second EM field generated by eddy currents in a metal object that interacts with the first EM field; determining, based on the received data, a location of the metal object; comparing the received data to model data; and classifying, based on the comparing of the received data and the model data, the metal object.

Any of the aspects herein, wherein the metal object is a pipe, and wherein classifying of the metal object includes determining a pipe thickness, a pipe diameter, and a material composition of the pipe.

Any of the aspects herein, wherein the material composition of the pipe is determined by comparing at least one of a primary polarizability, a secondary polarizability, or a tertiary polarizability to one or more model data sets depicting polarizability of a steel pipe, a copper pipe, and a lead pipe.

An apparatus according to at least one embodiment of the present disclosure comprises: a means for generating a first EM field; a means for receiving data describing a measured second EM field generated by eddy currents in a metal object that interacts with the first EM field; a means for comparing the received data to model data; and a means for classifying, based on the comparison of the received data to the model data, the metal object.

Any of the aspects herein, wherein the means for generating the first EM field comprises at least one EM transmitter coil that comprises a first EM transmitter coil that generates a first directional component of the first EM field, a second EM transmitter coil that generates a second directional component of the first EM field, and a third EM transmitter coil that generates a third directional component of the first EM field.

Any of the aspects herein, wherein the metal object includes a pipe, and wherein the received data include information about a primary polarizability, a secondary polarizability, and a tertiary polarizability of the pipe.

Any of the aspects herein, wherein the classifying of the metal object includes determining a pipe thickness, a pipe diameter, and a material composition of the pipe.

Any of the aspects herein, wherein the material composition of the pipe is determined by comparing at least one of the primary polarizability, the secondary polarizability, or the tertiary polarizability to one or more model data sets depicting polarizability of a steel pipe, a copper pipe, and a lead pipe.

Any of the aspects herein, wherein the one or more model data sets includes information about an amount of impurity of each of the steel pipe, the copper pipe, and the lead pipe.

Any of the aspects herein, wherein the amount of impurity includes a percentage of corrosion in each of the steel pipe, the copper pipe, and the lead pipe.

Any of the aspects herein, wherein determining the material composition of the pipe includes calculating a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

Any of the aspects herein, wherein determining the material composition of the pipe includes comparing the symmetry parameter value and the decay parameter value of the pipe to model symmetry parameter values and model decay parameter values of a steel pipe, a copper pipe, and a lead pipe.

An apparatus according to at least one embodiment of the present disclosure comprises: a means for generating a first EM field; a means for receiving data describing a measured second EM field generated by eddy currents in a metal object that interacts with the first EM field; and a means for determining, based on the received data, a location of the metal object.

Any of the aspects herein, wherein the means for generating the first EM field comprises at least one EM transmitter coil that comprises a first EM transmitter coil that generates a first directional component of the first EM field, a second EM transmitter coil that generates a second directional component of the first EM field, and a third EM transmitter coil that generates a third directional component of the first EM field.

Any of the aspects herein, wherein the metal object includes a pipe, and wherein the received data include information about a primary polarizability, a second polarizability, and a tertiary polarizability of the pipe.

Any of the aspects herein, wherein the metal object is disposed 50 centimeters (cm), 60 cm, 70 cm, 80 cm, 90 cm, 100 cm, or 110 cm below a ground surface.

Any of the aspects herein, wherein determining the location of the metal object comprises determining a location in 3D space.

Any of the aspects herein, wherein determining the location of the metal object comprises determining geolocation information about the metal object.

An apparatus according to at least one embodiment of the present disclosure comprises: a means for generating a first EM field; a means for receiving data describing a measured second EM field generated by eddy currents in a metal object that interacts with the first EM field; a means for determining, based on the received data, a location of the metal object; a means for comparing the received data to model data; and a means for classifying, based on the comparison of the received data and the model data, the metal object.

Any of the aspects herein, wherein the means for generating the first EM field comprises at least one EM transmitter coil that comprises a first EM transmitter coil that generates a first directional component of the first EM field, a second EM transmitter coil that generates a second directional component of the first EM field, and a third EM transmitter coil that generates a third directional component of the first EM field.

Any of the aspects herein, wherein the metal object includes a pipe, and wherein the received data include information about a primary polarizability, a secondary polarizability, and a tertiary polarizability.

Any of the aspects herein, wherein the classifying of the metal object includes determining a pipe thickness, a pipe diameter, and a material composition of the pipe.

Any of the aspects herein, wherein the material composition of the pipe is determined by comparing at least one of the primary polarizability, the secondary polarizability, or the tertiary polarizability to one or more model data sets depicting polarizability of a steel pipe, a copper pipe, and a lead pipe.

Any of the aspects herein, wherein the one or more model data sets includes information about an amount of impurity of each of the steel pipe, the copper pipe, and the lead pipe.

Any of the aspects herein, wherein the amount of impurity includes a percentage of corrosion in each of the steel pipe, the copper pipe, and the lead pipe.

Any of the aspects herein, wherein determining the material composition of the pipe includes calculating a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

Any of the aspects herein, wherein determining the material composition of the pipe includes comparing the symmetry parameter value and the decay parameter value of the pipe to model symmetry parameter values and model decay parameter values of a steel pipe, a copper pipe, and a lead pipe.

Any of the aspects herein, wherein the metal object is disposed 50 centimeters (cm), 60 cm, 70 cm, 80 cm, 90 cm, 100 cm, or 110 cm below a ground surface.

Any of the aspects herein, wherein determining the location of the metal object comprises determining a location in 3D space.

Any of the aspects herein, wherein determining the location of the metal object comprises determining geolocation information about the metal object.

A system according to at least one embodiment of the present disclosure comprises: a means for generating a first electromagnetic (EM) field; a means for receiving data describing a measured second EM field generated by eddy currents in a metal object that interacts with the first EM field; a means for determining, based on the received data, a location of the metal object; a means for comparing the received data to model data; and a means for classifying, based on the comparison of the received data and the model data, the metal object.

Any of the aspects herein, wherein the metal object is a pipe, and wherein classifying of the metal object includes determining a pipe thickness, a pipe diameter, and a material composition of the pipe.

Any of the aspects herein, wherein the material composition of the pipe is determined by comparing at least one of a primary polarizability, a secondary polarizability, or a tertiary polarizability to one or more model data sets depicting polarizability of a steel pipe, a copper pipe, and a lead pipe.

A method according to at least one embodiment of the present disclosure comprises: generating a first EM field; receiving data describing a measured second EM field generated by eddy currents in a metal object that interacts with the first EM field; comparing the received data to model data; and classifying, based on the comparison of the received data to the model data, the metal object.

Any of the aspects herein, wherein the generating the first EM field includes at least one EM transmitter coil that comprises a first EM transmitter coil that generates a first directional component of the first EM field, a second EM transmitter coil that generates a second directional component of the first EM field, and a third EM transmitter coil that generates a third directional component of the first EM field.

Any of the aspects herein, wherein the metal object includes a pipe, and wherein the received data include information about a primary polarizability, a secondary polarizability, and a tertiary polarizability of the pipe.

Any of the aspects herein, wherein the classifying of the metal object includes determining a pipe thickness, a pipe diameter, and a material composition of the pipe.

Any of the aspects herein, wherein the material composition of the pipe is determined by comparing at least one of the primary polarizability, the secondary polarizability, or the tertiary polarizability to one or more model data sets depicting polarizability of a steel pipe, a copper pipe, and a lead pipe.

Any of the aspects herein, wherein the one or more model data sets includes information about an amount of impurity of each of the steel pipe, the copper pipe, and the lead pipe.

Any of the aspects herein, wherein the amount of impurity includes a percentage of corrosion in each of the steel pipe, the copper pipe, and the lead pipe.

Any of the aspects herein, wherein determining the material composition of the pipe includes calculating a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

Any of the aspects herein, wherein determining the material composition of the pipe includes comparing the symmetry parameter value and the decay parameter value of the pipe to model symmetry parameter values and model decay parameter values of a steel pipe, a copper pipe, and a lead pipe.

A method according to at least one embodiment of the present disclosure comprises: generating a first EM field; receiving data describing a measured second EM field generated by eddy currents in a metal object that interacts with the first EM field; and determining, based on the received data, a location of the metal object.

Any of the aspects herein, wherein the generating the first EM field includes at least one EM transmitter coil that comprises a first EM transmitter coil that generates a first directional component of the first EM field, a second EM transmitter coil that generates a second directional component of the first EM field, and a third EM transmitter coil that generates a third directional component of the first EM field.

Any of the aspects herein, wherein the metal object includes a pipe, and wherein the received data include information about a primary polarizability, a second polarizability, and a tertiary polarizability of the pipe.

Any of the aspects herein, wherein the metal object is disposed 50 centimeters (cm), 60 cm, 70 cm, 80 cm, 90 cm, 100 cm, or 110 cm below a ground surface.

Any of the aspects herein, wherein determining the location of the metal object comprises determining a location in 3D space.

Any of the aspects herein, wherein determining the location of the metal object comprises determining geolocation information about the metal object.

A method according to at least one embodiment of the present disclosure comprises: generating a first EM field; receiving data describing a measured second EM field generated by eddy currents in a metal object that interacts with the first EM field; determining, based on the received data, a location of the metal object; comparing the received data to model data; and classifying, based on the comparison of the received data and the model data, the metal object.

Any of the aspects herein, wherein the generating the first EM field comprises at least one EM transmitter coil that comprises a first EM transmitter coil that generates a first directional component of the first EM field, a second EM transmitter coil that generates a second directional component of the first EM field, and a third EM transmitter coil that generates a third directional component of the first EM field.

Any of the aspects herein, wherein the metal object includes a pipe, and wherein the received data include information about a primary polarizability, a secondary polarizability, and a tertiary polarizability.

Any of the aspects herein, wherein the classifying of the metal object includes determining a pipe thickness, a pipe diameter, and a material composition of the pipe.

Any of the aspects herein, wherein the material composition of the pipe is determined by comparing at least one of the primary polarizability, the secondary polarizability, or the tertiary polarizability to one or more model data sets depicting polarizability of a steel pipe, a copper pipe, and a lead pipe.

Any of the aspects herein, wherein the one or more model data sets includes information about an amount of impurity of each of the steel pipe, the copper pipe, and the lead pipe.

Any of the aspects herein, wherein the amount of impurity includes a percentage of corrosion in each of the steel pipe, the copper pipe, and the lead pipe.

Any of the aspects herein, wherein determining the material composition of the pipe includes calculating a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

Any of the aspects herein, wherein determining the material composition of the pipe includes comparing the symmetry parameter value and the decay parameter value of the pipe to model symmetry parameter values and model decay parameter values of a steel pipe, a copper pipe, and a lead pipe.

Any of the aspects herein, wherein the metal object is disposed 50 centimeters (cm), 60 cm, 70 cm, 80 cm, 90 cm, 100 cm, or 110 cm below a ground surface.

Any of the aspects herein, wherein determining the location of the metal object comprises determining a location in 3D space.

Any of the aspects herein, wherein determining the location of the metal object comprises determining geolocation information about the metal object.

An apparatus according to at least one embodiment of the present disclosure comprises: a processor; at least one electromagnetic (EM) transmitter coil that generates a first EM field; and a memory storing instructions thereon that, when executed by the processor, cause the processor to: receive data describing a measured second EM field generated by eddy currents in a metal object that interacts with the first EM field; determine, based on the received data, a location of the metal object; compare the received data to model data; and classify, based on the comparison of the received data and the model data, the metal object.

Any of the aspects herein, wherein the metal object is a pipe, and wherein classifying of the metal object includes determining a pipe thickness, a pipe diameter, and a material composition of the pipe.

Any of the aspects herein, wherein the material composition of the pipe is determined by comparing at least one of a primary polarizability, a secondary polarizability, or a tertiary polarizability to one or more model data sets depicting polarizability of a steel pipe, a copper pipe, and a lead pipe.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Use of any one or more of the aspects or features as disclosed herein to identify and classify a metal object.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

Exemplary embodiments may be configured according to the following:

(1) An apparatus, comprising:
a processor;
at least one electromagnetic (EM) transmitter coil that generates a first EM field; and
a memory storing instructions thereon that, when executed by the processor, cause the processor to:
   receive data describing a measured second EM field generated by eddy currents in a metal object that interacts with the first EM field;
   compare the received data to model data; and
   classify, based on the comparing of the received data to the model data, the metal object.

(2) The apparatus of (1), wherein the at least one EM transmitter coil comprises a first EM transmitter coil that generates a first directional component of the first EM field, a second EM transmitter coil that generates a second directional component of the first EM field, and a third EM transmitter coil that generates a third directional component of the first EM field.

(3) The apparatus of one or more of (1) or (2), wherein the metal object includes a pipe, and wherein the received data include information about a primary polarizability, a secondary polarizability, and a tertiary polarizability of the pipe.

(4) The apparatus of any one or more of (1) to (3), wherein the classifying of the metal object includes determining a pipe thickness, a pipe diameter, and a material composition of the pipe.

(5) The apparatus of any one or more of (1) to (4), wherein the material composition of the pipe is determined by comparing at least one of the primary polarizability, the secondary polarizability, or the tertiary polarizability to one or more model data sets depicting polarizability of a steel pipe, a copper pipe, and a lead pipe.

(6) The apparatus of any one or more of (1) to (5), wherein the one or more model data sets includes information about an amount of impurity of each of the steel pipe, the copper pipe, and the lead pipe.

(7) The apparatus of any one or more of (1) to (6), wherein the amount of impurity includes a percentage of corrosion in each of the steel pipe, the copper pipe, and the lead pipe.

(8) The apparatus of any one or more of (1) to (7), wherein determining the material composition of the pipe includes calculating a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

(9) The apparatus of any one or more of (1) to (8), wherein determining the material composition of the pipe includes comparing the symmetry parameter value and the decay parameter value of the pipe to model symmetry parameter values and model decay parameter values of a steel pipe, a copper pipe, and a lead pipe.

(10) An apparatus, comprising:
a processor;
at least one electromagnetic (EM) transmitter coil that generates a first EM field; and
a memory storing instructions thereon that, when executed by the processor, cause the processor to:
   receive data describing a measured second EM field generated by eddy currents in a metal object that interacts with the first EM field; and
   determine, based on the received data, a location of the metal object.

(11) The apparatus of (10), wherein the at least one EM transmitter coil comprises a first EM transmitter coil that generates a first directional component of the first EM field, a second EM transmitter coil that generates a second directional component of the first EM field, and a third EM transmitter coil that generates a third directional component of the first EM field.

(12) The apparatus of one or more of (10) or (11), wherein the metal object includes a pipe, and wherein the received data include information about a primary polarizability, a second polarizability, and a tertiary polarizability of the pipe.

(13) The apparatus of any one or more of (10) to (12), wherein the metal object is disposed 50 centimeters (cm), 60 cm, 70 cm, 80 cm, 90 cm, 100 cm, or 110 cm below a ground surface.

(14) The apparatus of any one or more of (10) to (13), wherein determining the location of the metal object comprises determining a location in 3D space.

(15) The apparatus of any one or more of (10) to (14), wherein determining the location of the metal object comprises determining geolocation information about the metal object.

(16) An apparatus, comprising:
a processor;
at least one electromagnetic (EM) transmitter coil that generates a first EM field; and
a memory storing instructions thereon that, when executed by the processor, cause the processor to:
   receive data describing a measured second EM field generated by eddy currents in a metal object that interacts with the first EM field;
   determine, based on the received data, a location of the metal object;
   compare the received data to model data; and
   classify, based on the comparing of the received data and the model data, the metal object.

(17) The apparatus of (16), wherein the at least one EM transmitter coil comprises a first EM transmitter coil that generates a first directional component of the first EM field, a second EM transmitter coil that generates a second directional component of the first EM field, and a third EM transmitter coil that generates a third directional component of the first EM field.

(18) The apparatus of one or more of (16) to (17), wherein the metal object includes a pipe, and wherein the received data include information about a primary polarizability, a secondary polarizability, and a tertiary polarizability.

(19) The apparatus of any one or more of (16) to (18), wherein the classifying of the metal object includes determining a pipe thickness, a pipe diameter, and a material composition of the pipe.

(20) The apparatus of any one or more of (16) to (19), wherein the material composition of the pipe is determined by comparing at least one of the primary polarizability, the secondary polarizability, or the tertiary polarizability to one or more model data sets depicting polarizability of a steel pipe, a copper pipe, and a lead pipe.

(21) The apparatus of any one or more of (16) to (20), wherein the one or more model data sets includes information about an amount of impurity of each of the steel pipe, the copper pipe, and the lead pipe.

(22) The apparatus of any one or more of (16) to (21), wherein the amount of impurity includes a percentage of corrosion in each of the steel pipe, the copper pipe, and the lead pipe.

(23) The apparatus of any one or more of (16) to (22), wherein determining the material composition of the pipe includes calculating a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

(24) The apparatus of any one or more of (16) to (23), wherein determining the material composition of the pipe includes comparing the symmetry parameter value and the decay parameter value of the pipe to model symmetry parameter values and model decay parameter values of a steel pipe, a copper pipe, and a lead pipe.

(25) The apparatus of any one or more of (16) to (24), wherein the metal object is disposed 50 centimeters (cm), 60 cm, 70 cm, 80 cm, 90 cm, 100 cm, or 110 cm below a ground surface.

(26) The apparatus of any one or more of (16) to (25), wherein determining the location of the metal object comprises determining a location in 3D space.

(27) The apparatus of any one or more of (16) to (26), wherein determining the location of the metal object comprises determining geolocation information about the metal object.

(28) A method, comprising:
generating a first electromagnetic (EM) field;
receiving data describing a measured second EM field generated by eddy currents in a metal object that interacts with the first EM field;
determining, based on the received data, a location of the metal object;
comparing the received data to model data; and
classifying, based on the comparing of the received data and the model data, the metal object.

(29) The method of (28), wherein the metal object is a pipe, and wherein classifying of the metal object includes determining a pipe thickness, a pipe diameter, and a material composition of the pipe.

(30) The method of one or more of (28) to (29), wherein the material composition of the pipe is determined by comparing at least one of a primary polarizability, a secondary polarizability, or a tertiary polarizability to one or more model data sets depicting polarizability of a steel pipe, a copper pipe, and a lead pipe.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

1. An apparatus, comprising:
a processor;
at least one electromagnetic (EM) transmitter coil that generates a first EM field; and
a memory storing instructions thereon that are executable by the processor;
the processor configured to receive data describing a measured second EM field generated by eddy currents in a pipe that interacts with the first EM field;
the processor further configured to compare the received data to model data; and
the processor further configured to classify, based on the processor being configured to compare the received data to the model data, the pipe,
wherein the processor being further configured to classify the pipe includes the processor being further configured to determine a material composition of the pipe by the processor being configured to compare at least one of a primary polarizability, a secondary polarizability, or a tertiary polarizability to three model data sets, wherein a first data set of the three model data sets depicts polarizability of a steel pipe, wherein a second data set of the three model data sets depicts polarizability of a copper pipe, and wherein a third data set of the three model data sets depicts polarizability of a lead pipe.

2. The apparatus of claim 1, wherein the at least one EM transmitter coil comprises a first EM transmitter coil that generates a first directional component of the first EM field, a second EM transmitter coil that generates a second directional component of the first EM field, and a third EM transmitter coil that generates a third directional component of the first EM field.

3. The apparatus of claim 2, wherein the pipe is disposed 50 centimeters (cm), 60 cm, 70 cm, 80 cm, 90 cm, 100 cm, or 110 cm below a ground surface.

4. The apparatus of claim 3, wherein the processor being further configured to classify the pipe further comprises the processor being further configured to:
determine a pipe thickness and a pipe diameter.

5. (canceled)

6. The apparatus of claim 4, wherein the first data set includes information about an amount of impurity of the steel pipe, wherein the second data set includes information about an amount of impurity of the copper pipe, and wherein the third data set includes information about an amount of impurity of the lead pipe.

7. The apparatus of claim 6, wherein the amount of impurity of the first data set includes a percentage of corrosion in the steel pipe, wherein the amount of impurity of the second data set includes a percentage of corrosion in the copper pipe, and wherein the amount of impurity of the third data set includes a percentage of corrosion in the lead pipe.

8. The apparatus of claim 4, wherein the processor being further configured to determine the material composition of the pipe further comprises the processor being further configured to calculate
a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

9. The apparatus of claim 8, wherein the processor being further configured to determine the material composition of the pipe further comprises the processor being further configured to compare
the symmetry parameter value and the decay parameter value of the pipe to model symmetry parameter values and model decay parameter values of the steel pipe, the copper pipe, and the lead pipe.

10. An apparatus, comprising:
a processor;
at least one electromagnetic (EM) transmitter coil that generates a first EM field; and
a memory storing instructions thereon that are executable by the processor;
the processor configured to receive data describing a measured second EM field generated by eddy currents in a pipe that interacts with the first EM field, the data including information about a primary polarizability, a secondary polarizability, and a tertiary polarizability of the pipe;
the processor further configured to determine, based on the received data, a location of the pipe;
the processor further configured to compare the received data to model data; and
the processor further configured to classify, based on the processor being further configured to compare the received data to the model data, the pipe by the processor being further configured to determine a material composition of the pipe based on the processor being further configured to compare at least one of the primary polarizability, a secondary polarizability, or a tertiary polarizability to three model data sets, wherein a first data set of the three model data sets depicts polarizability of a steel pipe, wherein a second data set of the three model data sets depicts polarizability of a copper pipe, and wherein a third data set of the three model data sets depicts polarizability of a lead pipe.

11. The apparatus of claim 10, wherein the at least one EM transmitter coil comprises a first EM transmitter coil that generates a first directional component of the first EM field, a second EM transmitter coil that generates a second directional component of the first EM field, and a third EM transmitter coil that generates a third directional component of the first EM field.

12. (canceled)

13. The apparatus of claim 10, wherein the pipe is disposed 50 centimeters (cm), 60 cm, 70 cm, 80 cm, 90 cm, 100 cm, or 110 cm below a ground surface.

14. The apparatus of claim 10, wherein the determined location is a location in 3D space.

15. The apparatus of claim 14, wherein the processor being further configured to determine the location further comprises the processor being further configured to
determine geolocation information about the pipe.

16. An apparatus, comprising:
a processor;
at least one electromagnetic (EM) transmitter coil that generates a first EM field; and
a memory storing instructions thereon that are executable by the processor;
the processor configured to receive data describing a measured second EM field generated by eddy currents in a pipe that interacts with the first EM field;
the processor further configured to determine, based on the received data, a location of the pipe;
the processor further configured to compare the received data to model data; and
the processor further configured to classify, based on the processor being further configured to compare the received data and the model data, the pipe by the processor being further configured to determine a material composition of the pipe by the processor being further configured to compare at least one of a primary polarizability, a secondary polarizability, or a tertiary polarizability to three model data sets, a first data set of the three model data sets depicting polarizability of a steel pipe, a second data set of the three model data sets depicting polarizability of a copper pipe, and a third data set of the three model data sets depicting polarizability of a lead pipe.

17. The apparatus of claim 16, wherein the at least one EM transmitter coil comprises a first EM transmitter coil that generates a first directional component of the first EM field, a second EM transmitter coil that generates a second directional component of the first EM field, and a third EM transmitter coil that generates a third directional component of the first EM field.

18. The apparatus of claim 17, wherein the received data includes the primary polarizability, the secondary polarizability, and the tertiary polarizability.

19. The apparatus of claim 18, wherein the processor being further configured to classify the pipe further comprises the processor being further configured to
determine a pipe thickness and a pipe diameter.

20. (canceled)

21. The apparatus of claim 19, wherein the first data set includes information about an amount of impurity of the steel pipe, wherein the second data set includes information about an amount of impurity of the copper pipe, and wherein the third data set includes information about an amount of impurity of the lead pipe.

22. The apparatus of claim 21, wherein the amount of impurity of the first data set includes a percentage of corrosion in the steel pipe, wherein the amount of impurity of the second data set includes a percentage of corrosion in the copper pipe, and wherein the amount of impurity of the third data set includes a percentage of corrosion in the lead pipe.

23. The apparatus of claim 19, wherein the processor being further configured to determine the material composition of the pipe further comprises the processor being further configured to calculate
a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

24. The apparatus of claim 23, wherein the processor being further configured to determine the material composition of the pipe further comprises the processor being further configured to compare
the symmetry parameter value and the decay parameter value of the pipe to model symmetry parameter values and model decay parameter values of the steel pipe, the copper pipe, and the lead pipe.

25. The apparatus of claim 16, wherein the pipe is disposed 50 centimeters (cm), 60 cm, 70 cm, 80 cm, 90 cm, 100 cm, or 110 cm below a ground surface.

26. The apparatus of claim 16, wherein the processor being further configured to determine the location of the pipe further comprises the processor being further configured to
determine a location of the pipe in 3D space.

27. The apparatus of claim 26, wherein the processor being configured to determine the location of the pipe further comprises the processor being further configured to
determine geolocation information about the pipe.

28. A method, comprising:
generating a first electromagnetic (EM) field;
receiving data describing a measured second EM field generated by eddy currents in a pipe that interacts with the first EM field;
determining, based on the received data, a location of the pipe;
comparing the received data to model data; and
classifying, based on the comparing of the received data and the model data, the pipe, the classifying comprising determining a material composition of the pipe by comparing at least one of a primary polarizability, a secondary polarizability, or a tertiary polarizability to three model data sets, wherein a first model data set of the three model data sets depicts polarizability of a steel pipe, wherein a second model data set of the three model data sets depicts polarizability of a copper pipe, and wherein a third model data set of the three model data sets depicts polarizability of a lead pipe.

29. The method of claim 28, wherein classifying of the pipe includes determining a pipe thickness and a pipe diameter.

30. (canceled)

31. The apparatus of claim 10, wherein the processor being further configured to determine the material composition of the pipe further comprises the processor being further configured to calculate
a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

32. The apparatus of claim 31, wherein the processor being further configured to determine the material composition of the pipe further comprises the processor being further configured to compare
the symmetry parameter value and the decay parameter value of the pipe to model symmetry parameter values and model decay parameter values of the steel pipe, the copper pipe, and the lead pipe.

33. The method of claim 28, wherein determining the material composition further comprises:
calculating a symmetry parameter value and a decay parameter value of the pipe, wherein the symmetry parameter value is a ratio of the primary polarizability and the secondary polarizability, wherein the decay parameter value is a ratio of the primary polarizability at a first time and the primary polarizability at a second time, and wherein the first time is later than the second time.

34. The method of claim 33, wherein determining the material composition further comprises:
comparing the symmetry parameter value and the decay parameter value of the pipe to model symmetry parameter values and model decay parameter values of the steel pipe, the copper pipe, and the lead pipe.
